(19) United States
(12) Patent Application Publication
(10) Pub. No.: US 2025/0305978 A1
(43) Pub. Date: Oct. 2, 2025

(54) GAS SENSOR

(71) Applicant: TDK Corporation, Tokyo (JP)

(72) Inventors: Kei TANABE, Tokyo (JP); Yutaka MATSUO, Tokyo (JP)

(21) Appl. No.: 19/071,887

(22) Filed: Mar. 6, 2025

(30) Foreign Application Priority Data
Mar. 26, 2024 (JP) 2024-049649

(51) Int. Cl. G01N 27/18

(52) U.S. Cl. CPC G01N 27/18

(57) ABSTRACT

Disclosed herein is a gas sensor that includes a sensor part configured to generate a detection signal indicating a concentration of a gas to be detected, and a control circuit configured to calculate the concentration of the gas to be detected based on the detection signal. The sensor part includes a temperature-sensitive element and a heater configured to heat the temperature-sensitive element. The control circuit is configured to obtain, in a disturbance information measurement period, disturbance information based on a resistance value of the temperature-sensitive element or a resistance value of the heater in a state where the temperature-sensitive element is heated to a first temperature range by the heater and obtain, in a gas concentration measurement period, the detection signal by heating the temperature-sensitive element to a second temperature range by the heater under a heating condition corresponding to the disturbance information.

### CROSS-REFERENCE TO RELATED APPLICATION

This application claims the benefit of Japanese Patent Application No. 2024-049649, filed on Mar. 26, 2024, the entire disclosure of which is incorporated by reference herein.

### BACKGROUND OF THE ART

### Field of the Art

The present disclosure relates to a gas sensor and, more particularly, to a gas sensor capable of accurately measuring gas concentration irrespective of disturbance conditions in measuring atmosphere.

### Description of Related Art

Japanese Patent No. 7,070,175 discloses a gas sensor capable of reducing a measurement error caused by a gas different from a detection target gas.

### SUMMARY

A gas sensor according to an aspect of the present disclosure includes: a sensor part configured to generate a detection signal indicating a concentration of a gas to be detected; and a control circuit configured to calculate the concentration of the gas to be detected based on the detection signal, wherein the sensor part includes a first temperature-sensitive element and a first heater configured to heat the first temperature-sensitive element, and the control circuit is configured to obtain, in a disturbance information measurement period, disturbance information based on a resistance value of the first temperature-sensitive element or a resistance value of the first heater in a state where the first temperature-sensitive element is heated to a first temperature range by the first heater and obtain, in a gas concentration measurement period, the detection signal by heating the first temperature-sensitive element to a second temperature range by the first heater under a heating condition corresponding to the disturbance information.

A gas sensor according to another aspect of the present disclosure includes: a sensor part configured to generate a detection signal indicating a concentration of a gas to be detected; and a control circuit configured to calculate the concentration of the gas to be detected based on the detection signal, wherein the sensor part includes temperature-sensitive element, a first a second temperature-sensitive element, a first heater configured to heat the first temperature-sensitive element, and a second heater configured to heat the second temperature-sensitive element, and the control circuit is configured to obtain, in a disturbance information measurement period, disturbance information based on a resistance value of the first temperature-sensitive element or a resistance value of the first heater in a state where the first temperature-sensitive element is heated to a first temperature range by the first heater and obtain, in a gas concentration measurement period, the detection signal by heating the second temperature-sensitive element to a second temperature range by the second heater under a heating condition corresponding to the disturbance information.

A gas sensor according to still another aspect of the present disclosure includes: a sensor part configured to generate a detection signal in accordance with a concentration of a gas to be detected; and a control circuit configured to calculate the concentration of the gas to be detected based on the detection signal, wherein the sensor part includes a temperature-sensitive element, a first heater, and a second heater configured to heat the temperature-sensitive element, and the control circuit is disturbance information configured to obtain, in a measurement period, disturbance information based on a resistance value of the first heater in a state where the first heater is heated to a first temperature range and obtain, in a gas concentration measurement period, the detection signal by heating the temperature-sensitive element to a second temperature range by the second heater under a heating condition corresponding to the disturbance information.

### BRIEF DESCRIPTION OF THE DRAWINGS

The above features and advantages of the present disclosure will be more apparent from the following description of some embodiments taken in conjunction with the accompanying drawings, in which:

FIG. 1 is a circuit diagram illustrating the configuration of a gas sensor 100 according to a first embodiment of the technology described herein;

FIG. 2 is a graph illustrating the relationship between heated temperature and detection sensitivity of the thermistor 11;

FIGS. 3A and 3B are circuit examples of the reference voltage generating circuit 32;

FIG. 4 is a flowchart for explaining the operation of the gas sensor 100;

FIG. 5 is a timing chart for explaining a method of setting the heater voltage V13 in the first embodiment;

FIGS. 6A and 6B are flowcharts for explaining the modified operation of the gas sensor 100;

FIG. 7 is a circuit diagram illustrating the configuration of a gas sensor 200 according to a second embodiment of the technology described herein;

FIG. 8 is a timing chart for explaining a method of setting the heating time in the second embodiment;

FIG. 9 is a circuit diagram illustrating the configuration of a gas sensor 300 according to a third embodiment of the technology described herein;

FIG. 10 is a circuit diagram illustrating the configuration of a gas sensor 400 according to a fourth embodiment of the technology described herein;

FIG. 11 is a timing chart for explaining a first setting method in the fourth embodiment;

FIG. 12 is a timing chart for explaining a second setting method in the fourth embodiment;

FIG. 13 is a timing chart for explaining a third setting method in the fourth embodiment;

FIG. 14 is a timing chart for explaining a fourth setting method in the fourth embodiment;

FIG. 15 is a circuit diagram illustrating the configuration of a gas sensor 500 according to a fifth embodiment of the technology described herein;

FIG. 16 is a circuit diagram illustrating the configuration of a gas sensor 600 according to a sixth embodiment of the technology described herein;

FIG. 17 is a timing chart for explaining a first setting method in the sixth embodiment;

FIG. 18 is a timing chart for explaining a second setting method in the sixth embodiment;

FIG. 19 is a circuit diagram illustrating the configuration of a gas sensor 700 according to a seventh embodiment of the technology described herein;

FIG. 20 is a circuit diagram illustrating the configuration of a gas sensor 800 according to an eighth embodiment of the technology described herein; and

FIG. 21 is a circuit diagram illustrating the configuration of a gas sensor 900 according to a ninth embodiment of the technology described herein.

### DETAILED DESCRIPTION OF THE EMBODIMENTS

The present inventor has found that a measurement error is caused due to a disturbance (gas flow etc.) in measuring atmosphere.

The present disclosure describes a technology relating to a gas sensor capable of accurately measuring gas concentration irrespective of disturbance conditions in measuring atmosphere.

Some embodiments of the present disclosure will be explained below in detail with reference the accompanying drawings.

### First Embodiment

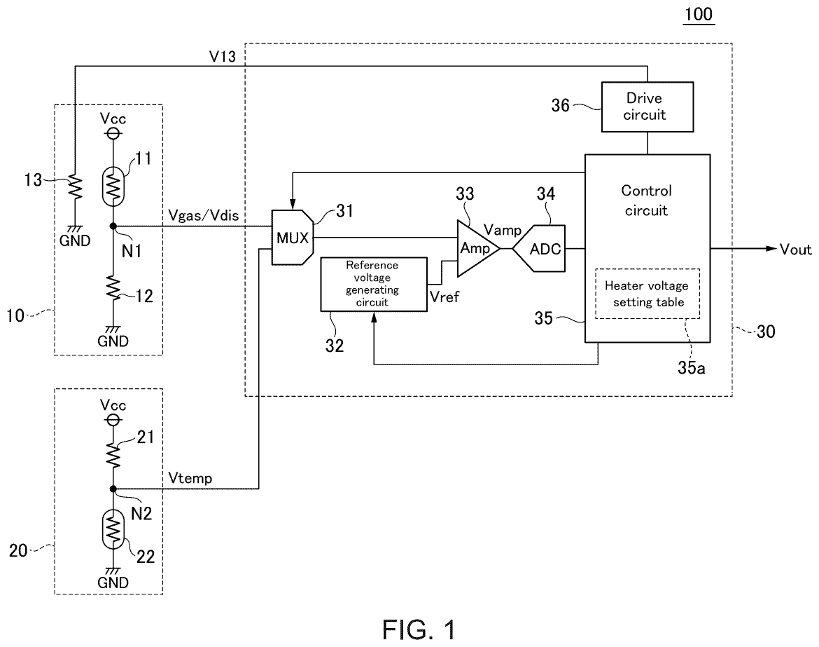

FIG. 1 is a circuit diagram illustrating the configuration of a gas sensor 100 according to a first embodiment of the technology described herein.

As illustrated in FIG. 1, the gas sensor 100 according to the first embodiment includes a sensor part 10 that generates a detection signal Vgas corresponding to the concentration of a gas to be detected, a temperature sensor 20 that generates a temperature signal Vtemp corresponding to environmental temperature, and a signal processing circuit 30. Although not particularly limited, the gas sensor 100 according to the present embodiment is a heat-conduction type gas sensor for detecting the concentration of CO₂ gas in measuring atmosphere.

The sensor part 10 includes a thermistor 11 and a resistor 12 which are connected in series between a power supply Vcc and a ground GND and a heater 13 for heating the thermistor 11. The detection signal Vgas output from the sensor part 10 appears at a node N1 between the thermistor 11 and the resistor 12. The thermistor 11 is a temperature-sensitive element for detection. The thermistor 11 is a resistor whose resistance value varies with temperature. Examples of the material of the thermistor 11 and thermistors 14, 16, and 22 to be described later include vanadium oxide, amorphous silicon, polycrystalline silicon, an oxide with a spinel crystal structure containing manganese, titanium oxide, and yttrium-barium-copper oxide.

When CO₂ gas is present in measuring atmosphere in a state where the thermistor 11 as the temperature-sensitive element for detection is heated to a predetermined temperature range (e.g., a temperature range around 150° C.) between 100° C. and 230° C. which is a temperature zone exhibiting high CO₂ gas detection sensitivity, heat dissipation characteristics of the thermistor 11 change in accordance with the concentration of the CO₂ gas. The “temperature range” in this specification may have a temperature width equal to less than 1° C. For example, a temperature range around 150° C. may have a width of 149.5° C. or more and 150.5° C. or less. This change appears as a change in the temperature of the thermistor 11, i.e., a change in the resistance value thereof. CO₂ gas is lower in heat dissipation performance than air, so that the temperature of the thermistor 11 increases as the concentration of CO₂ gas increases. Here, assume that heating is performed so that temperature of the thermistor 11 becomes 150° C. in measuring atmosphere where CO₂ gas concentration is, for example, zero. In this case, if CO₂ gas is present in measuring atmosphere, the temperature of the thermistor 11 increases with an increase in the CO₂ gas concentration and exceeds 150° C. As a result, the resistance value of the thermistor 11 lowers as the CO₂ gas concentration in measuring atmosphere increases.

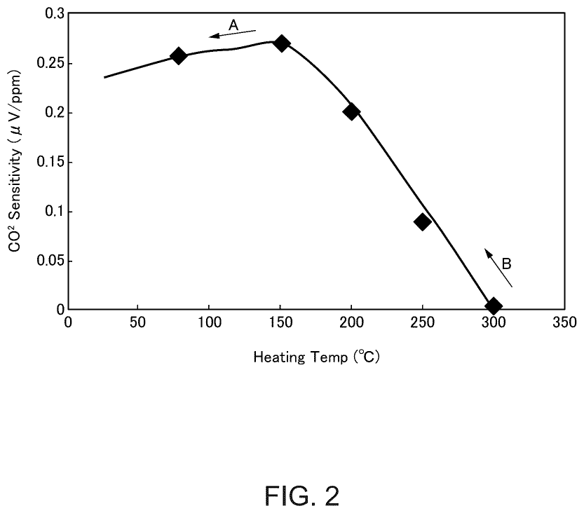

FIG. 2 is a graph illustrating the relationship between heated temperature and detection sensitivity of the thermistor 11.

As illustrated in FIG. 2, the relationship between the detection sensitivity of the thermistor 11, i.e., CO₂ gas concentration in n measuring atmosphere and the resistance value of the thermistor 11 significantly varies depending on the heated temperature of the thermistor 11. That is, the detection sensitivity of the thermistor 11 becomes maximum at about 150° C. and substantially zero in a temperature range equal to or more than 300° C. The temperature dependency of the detection sensitivity of the thermistor 11 results from the temperature dependency of the heat dissipation characteristics of CO₂ gas which is a gas to be detected. The difference in heat dissipation characteristics between CO₂ gas and air becomes maximum at around 150° C., whereas it becomes substantially zero in a temperature range equal to or more than 300° C.

The temperature sensor 20 includes a resistor 21 and a thermistor 22 which are connected in series between the power supply Vcc and the ground GND. A temperature signal Vtemp of the temperature sensor 20 appears at a node N2 between the resistor 21 and the thermistor 22. The temperature sensor 20 detects environmental temperature. Environmental temperature is a temperature in measuring atmosphere. The temperature sensor 20 may be designed so as not to be affected or so as to be hardly affected by heating by, for example, the heater 13.

The signal processing circuit 30 includes a multiplexer 31, a reference voltage generating circuit 32, a differential amplifier 33, an AD converter (ADC) 34, a control circuit 35, and a drive circuit 36.

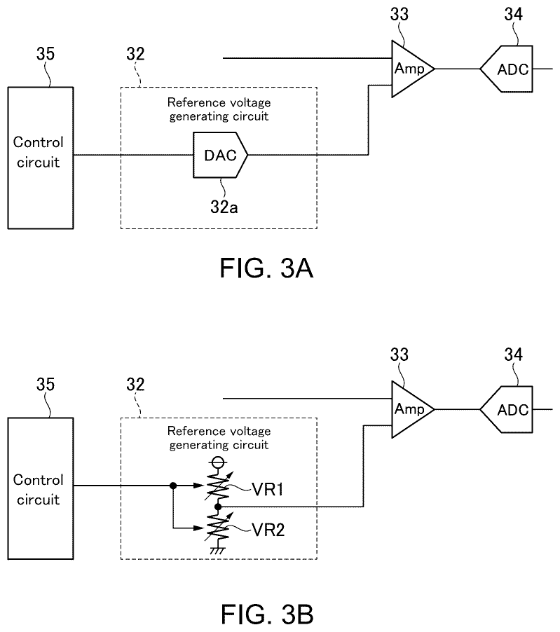

The multiplexer 31 supplies one of the detection signal Vgas or Vdis and temperature signal Vtemp to the differential amplifier 33 under the control of the control circuit 35. As described later, the detection signal Vdis is a signal appearing at the node N1 between the thermistor 11 and the resistor 12 at the measurement of disturbance information. The differential amplifier 33 generates an amplified signal Vamp which is a signal obtained by amplifying the difference (potential difference) between the level of one of the detection signal Vgas or Vdis and temperature signal Vtemp and the level of a reference signal Vref generated by the reference voltage generating circuit 32. The reference voltage generating circuit 32 may be constituted by a DA converter 32a (FIG. 3A) that D-A converts a digital value output from the control circuit 35 or by variable resistors VR1 and VR2 (FIG. 3B) whose resistance values are controlled by the control circuit 35.

The amplified signal Vamp output from the differential amplifier 33 is input to the AD converter 34. The AD converter 34 A-D converts the amplified signal Vamp to generate a digital value and supplies the generated digital value to the control circuit 35.

The control circuit 35 calculates the concentration of CO₂ gas which is a gas to be detected based on the amplified signal Vamp of the detection signal Vgas and generates an output signal Vout indicating the CO₂ gas concentration. The control circuit 35 calculates the CO₂ gas concentration using a calculation formula set therein. Further, the control circuit 35 controls, through the drive circuit 36, the level of the heater voltage V13 to be supplied to the heater 13.

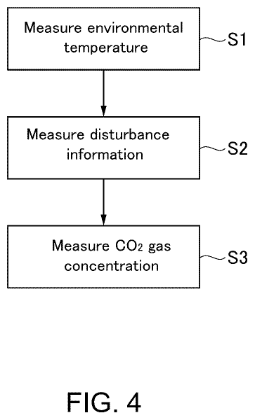

FIG. 4 is a flowchart for explaining the operation of the gas sensor 100 according to the present embodiment.

The gas sensor 100 according to the present embodiment measures environmental temperature (step S1) and disturbance information (step S2) before measuring CO₂ gas concentration (step S3).

In the measurement of environmental temperature (step S1), the amplified signal Vamp of the temperature signal Vtemp is referred to obtain information concerning environmental temperature. Based on the amplified signal Vamp of the temperature signal Vtemp, the control circuit 35 sets the value of the heater voltage V13 so that the temperature of the thermistor 11 becomes a predetermined value irrespective of environmental temperature. For example, the control circuit 35 sets the value of the heater voltage V13 so that the temperature of the thermistor 11 becomes 350° C. or 150° C. irrespective of environmental temperature in measuring atmosphere where CO₂ gas concentration is, for example, zero.

In the measurement of disturbance information (step S2), the heater voltage V13 is set to a measurement level of the disturbance information to thereby heat the thermistor 11 to a predetermined temperature range (e.g., a temperature range around 350° C.) between 320° C. and 450° C. The control circuit 35 may set the measurement level of disturbance information based on environmental temperature (amplified signal Vamp of the temperature signal Vtemp). In this case, the control circuit 35 changes the level of the heater voltage V13 set in the measurement of disturbance information (step S2) in accordance with the temperature signal Vtemp (amplified signal Vamp of the temperature signal Vtemp) to change power applied to the heater 13, thereby changing the heat generation amount of the heater 13. As described using FIG. 2, even when CO₂ gas is present in measuring atmosphere in a state where the thermistor 11 is heated to 300° C. or higher, the heat dissipation characteristics of the thermistor 11 hardly change in accordance with the concentration of CO₂ gas, with the result that the temperature of the thermistor 11 hardly changes. However, when a disturbance (gas flow, high humidity, etc.) which may affect the measurement of CO₂ gas concentration is present in measuring atmosphere, if the level of the heater voltage V13 is adjusted so that the thermistor 11 is heated to about 300° C. without the disturbance being taken into account, the temperature of the thermistor 11 does not reach a target temperature (in this case, 350° C.).

On the other hand, in a temperature range equal to or more than 300° C., the thermistor 11 has little sensitivity to CO₂ gas, a decrease in temperature of the thermistor 11 in the measurement of disturbance information (step S2) is irrelevant to the concentration of CO₂ gas in measuring atmosphere and is thus considered to be caused exclusively due to a disturbance. In order for this condition to be satisfied even under a large disturbance, the disturbance information measurement level for the heater voltage V13 may be set so that the thermistor 11 is heated to 300° C. or higher in the measurement of disturbance information (step S2) even when an assumable maximum disturbance is present. Therefore, the control circuit 35 may omit the measurement of environmental temperature (step S1) and set the disturbance information measurement level for the heater voltage V13 to a predetermined fixed value. In this case, for example, the disturbance information measurement level for the heater voltage V13 is set so that the thermistor 11 is heated to 350° C. in the measurement of disturbance information (step S2) under the conditions that the temperature (environmental temperature) of measuring atmosphere is 25° C. and that gas flow velocity in measuring atmosphere is zero.

The flow of gas in measuring atmosphere has particularly significant influence on measurement of CO₂ gas concentration as a disturbance, outside of fluctuation in environmental temperature. When gas flow occurs in measuring atmosphere, the thermistor 11 and heater 13 are cooled by the gas flow, and thus the heating temperature of the thermistor 11 and heater 13 decreases. Thus, as the gas flow velocity increases, the heating temperature of the thermistor 11 and heater 13 decreases, with the result that the detection signal Vdis (disturbance information) obtained in the measurement of disturbance information (step S2) changes. This means that the heating temperature of the thermistor 11 and heater 13 does not reach a desired temperature (e.g., 150° C.) when the thermistor 11 and heater 13 are heated with the disturbance information not taken into consideration in the measurement of CO₂ gas concentration (step S3). The detection signal Vdis obtained in the measurement of disturbance information (step S2) is disturbance information based on the resistance value of the thermistor 11. As is the case with the detection signal Vgas, the detection signal Vdis appears at the node N1 between the thermistor 11 and the resistor 12. That is, a signal that appears at the node N1 in the measurement of disturbance information (step S2) is the detection signal Vdis, and a signal that appears at the node N1 in the measurement of CO₂ gas concentration (step S3) is the detection signal Vgas.

The control circuit 35 sets the level of the heater voltage V13 in the measurement of CO₂ gas concentration (step S3) so as to cancel such a decrease in the heating temperature. The control circuit 35 performs the level setting for the heater voltage V13 by referring to a heater voltage setting table 35a included therein. The heater voltage setting table 35a is a data table indicating the relationship between the detection signal Vdis obtained in the measurement of disturbance information (step S2) and information concerning the heater voltage V13 in the measurement of CO₂ gas concentration (step S3).

For example, when the measurement level of disturbance information is set in the measurement of disturbance information (step S2) based on information (amplified signal Vamp of the temperature signal Vtemp) concerning environmental temperature obtained in the measurement of environmental temperature (step S1), the control circuit 35 may set as the heater voltage V13, in the measurement of CO₂ gas concentration (step S3), a value obtained by adding a correction value which is obtained from the heater voltage setting table 35a based on the detection signal Vdis as the disturbance information to the value of the heater voltage V13 determined based on information (amplified signal Vamp of the temperature signal Vtemp) concerning environmental temperature. In this case, the information concerning the heater voltage V13 of the heater voltage setting table 35a in the measurement of CO₂ gas concentration (step S3) is the correction value to be added to the heater voltage V13 determined based on the information concerning environmental temperature in the measurement of CO₂ gas concentration (step S3).

Further, for example, the measurement level of the disturbance information is set to a predetermined fixed value with the measurement of environmental temperature (step S1) omitted, the information concerning the heater voltage V13 in the measurement of CO₂ gas concentration (step S3) may be the level of the heater voltage V13 in the measurement of CO₂ gas concentration (step S3). In this case, in the measurement of CO₂ gas concentration (step S3), the control circuit 35 sets, as heater voltage V13, the level which is obtained from the heater voltage setting table 35a based on the detection signal Vdis as the disturbance information.

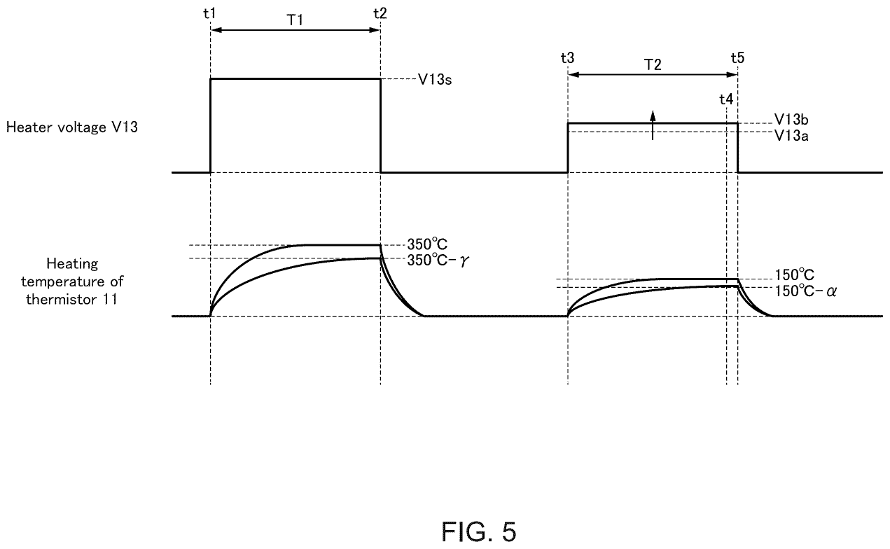

FIG. 5 is a timing chart for explaining a method of setting the heater voltage V13 in the first embodiment.

In the example illustrated in FIG. 5, the measurement of disturbance information (step S2) is executed in the period T1 from time t1 to time t2. The level V13s illustrated in FIG. 5 is the level (measurement level of the disturbance information for the heater voltage V13) of the heater voltage V13 at the measurement of the disturbance information. When the level of the heater voltage V13 is set to V13s, the heating temperature of the thermistor 11 and heater 13 becomes 350° C. in the absence of a disturbance such as gas flow in measuring atmosphere. However, when a disturbance such as gas flow is present in measuring atmosphere in this state, the thermistor 11 and heater 13 are cooled by gas flow or the like, and thus the heating temperature of the thermistor 11 and heater 13 decreases to 350° C.-γ. As a result, the detection signal Vdis (disturbance information) changes.

In the example illustrated in FIG. 5, the measurement of CO₂ gas concentration (step S3) is executed in the period T2 from time t3 to time t5. The level V13a illustrated in FIG. 5 is the level of the heater voltage V13 in the absence of a disturbance, for example, when gas flow velocity in measuring atmosphere is zero. That is, when the level of the heater voltage V13 is set to V13a in the absence of a disturbance, the heating temperature of the thermistor 11 and heater 13 becomes about 150° C.

However, in a case where a disturbance such as gas flow is present in measuring atmosphere, when the level of the heater voltage V13 is set to V13a, the thermistor 11 and heater 13 are cooled by the disturbance. Therefore, when CO₂ gas concentration in measuring atmosphere is, for example, zero, the heating temperature of the thermistor 11 and heater 13 decreases to 150° C.-α, not 150° C. The control circuit 35 sets the level of the heater voltage V13 to V13b (>V13a) in accordance with the disturbance information obtained in step S2 so as to cancel such a decrease in the heating temperature. Thus, even when a disturbance such as gas flow is present in measuring atmosphere, if the CO₂ gas concentration in measuring atmosphere is, for example, zero, the thermistor 11 and heater 13 are properly heated to 150° C. Then, by sampling the detection signal Vgas at time t4 immediately before time t5, it is possible to accurately measure gas concentration.

As described above, the gas sensor 100 according to the first embodiment changes the level of the heater voltage V13 in the measurement period of CO₂ gas concentration in accordance with the disturbance information to change power applied to the heater 13, thereby changing the heat generation amount of the heater 13. The setting value of the heater voltage V13 in the measurement period of CO₂ gas concentration is determined by the detection signal Vdis as the disturbance information. Further, the difference in heat dissipation characteristics between CO₂ gas (gas to be detected) and air in a temperature range (first temperature range) around 350° C. is smaller than that in a temperature range (second temperature range) around 150° C., so that, in the gas sensor 100 according to the first embodiment, the sensitivity of the thermistor 11 with respect to CO₂ gas (gas to be detected) in the temperature range (first temperature range) around 350° C. is lower than that in the temperature range (second temperature range) around 150° C. The first temperature range which is a predetermined temperature range (in this example, a temperature range around 350° C.) between 320° C. and 450° C. differs from the second temperature range which is a predetermined temperature range (in this example, a temperature range around 150° C.) between 100° C. and 230° C. and is higher in temperature than the second temperature range. This makes it possible to accurately detect CO₂ gas concentration irrespective of the influence of a disturbance in measuring atmosphere.

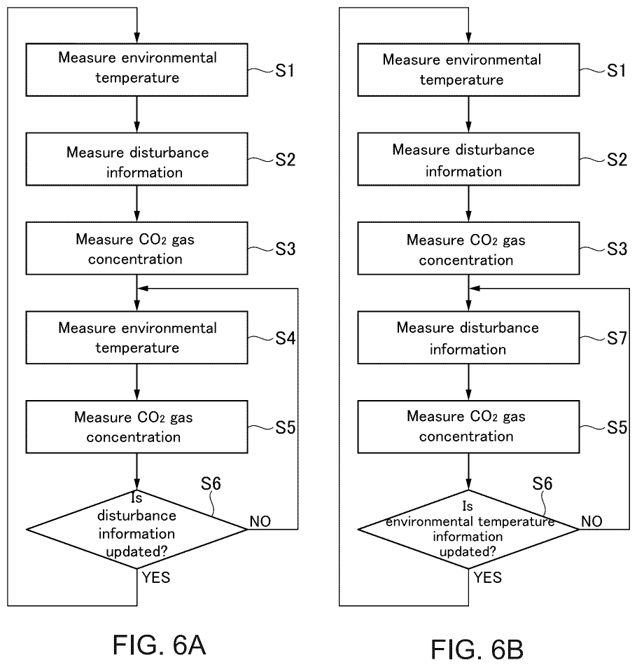

In the present embodiment, the measurement of disturbance information (step S2) need not be executed every time before execution of the measurement of CO₂ gas concentration (step S3) but may be executed intermittently. For example, a process sequence illustrated in the flowchart of FIG. 6A may be possible, in which the measurement of environmental temperature (step S1), the measurement of disturbance information (step S2), and the measurement of CO₂ gas concentration (step S3) are executed, and successively, the measurement of environment temperature (step S4) and the measurement of CO₂ gas concentration (step S5) are executed. After that, steps S4 to S6 are repeated until update timing of the disturbance information is reached, and the processing flow is returned to step S1 at the update timing of the disturbance information. This can reduce power consumption in a state where a disturbance state does not change significantly in a short period of time and can perform measurement of CO₂ gas concentration more frequently. In the flowchart of FIG. 6A, one of or both the measurement of environmental temperature (step S1) and measurement of environmental temperature (step S4) may be omitted.

Alternatively, a process sequence illustrated in the flowchart of FIG. 6B may be possible, in which the measurement of environmental temperature (step S1), the measurement of disturbance information (step S2), and the measurement of CO₂ gas concentration (step S3) are executed, and successively, the measurement of disturbance information (step S7) and measurement of CO₂ gas concentration (step S5) are executed. After that, steps S5 to S7 are repeated until update timing of environmental temperature is reached, and the processing flow is returned to step S1 at the update timing of environmental temperature. This can reduce power consumption in a state where environmental temperature does not change significantly in a short period of time and can perform the measurement of CO₂ gas concentration more frequently. In the flowchart of FIG. 6B, the measurement of environmental temperature (step S1) may be omitted.

### Second Embodiment

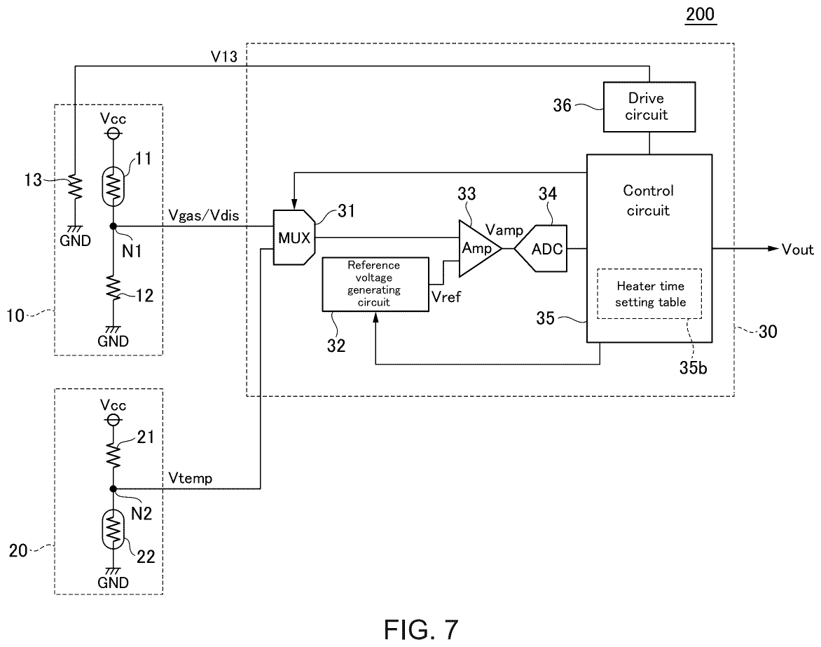

FIG. 7 is a circuit diagram illustrating the configuration of a gas sensor 200 according to a second embodiment of the technology described herein.

As illustrated in FIG. 7, the gas sensor 200 according to the second embodiment differs from the gas sensor 100 according to the first embodiment in that the control circuit 35 includes a heating time setting table 35b in place of the heater voltage setting table 35a. Other basic configurations are the same as those of the gas sensor 100 according to the first embodiment, so the same reference numerals are given to the same elements, and overlapping description will be omitted.

In the second embodiment, the heating time setting table 35b is used to correct application time of the heater voltage V13 so as to cancel a measurement error caused due to a disturbance such as gas flow in measuring atmosphere.

The heating time setting table 35b is a data table indicating the relationship between the detection signal Vdis obtained in the measurement of disturbance information (step S2) and information concerning the application time of the heater voltage V13 in the measurement of CO₂ gas concentration (step S3).

For example, in the measurement of disturbance information (step S2), the measurement level of disturbance information is set based on information (amplified signal Vamp of the temperature signal Vtemp) concerning environmental temperature obtained in the measurement of environmental temperature (step S1). In this case, in the measurement of CO₂ gas concentration (step S3), the control circuit 35 may set the heater voltage V13 based on the information (amplified signal Vamp of the temperature signal Vtemp) concerning environmental temperature and set, as the application time of the heater voltage V13, a value obtained by adding a correction time obtained from the heating time setting table 35b based on the detection signal Vdis as the distribution information to the application time of the heater voltage V13 determined based on the information (amplified signal Vamp of the temperature signal Vtemp) concerning environmental temperature. The information concerning the application time of the heater voltage V13 of the heating time setting table 35b read in the measurement of CO₂ gas concentration (step S3) is the correction time to be added to the application time of the heater voltage V13 determined based on the information concerning environmental temperature in the measurement of CO₂ gas concentration (step S3).

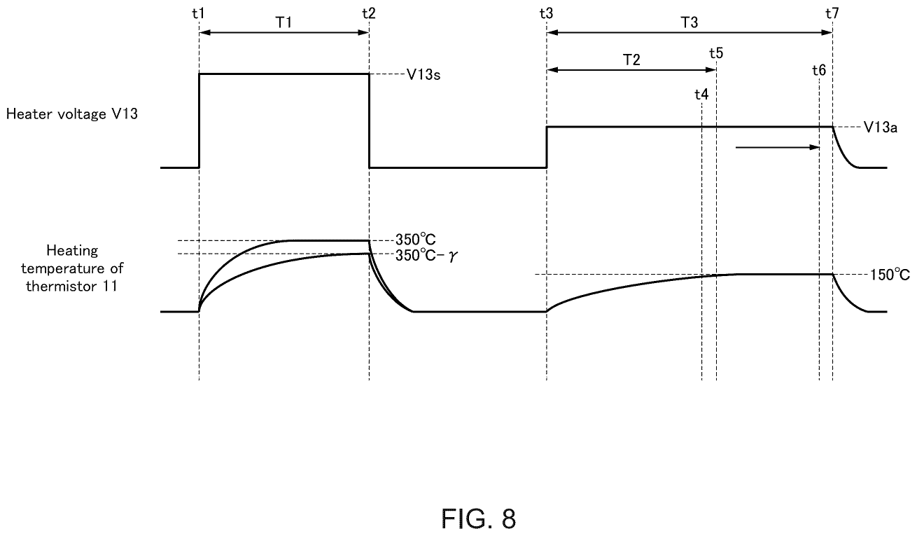

FIG. 8 is a timing chart for explaining a method of setting the heating time in the second embodiment.

In the example illustrated in FIG. 8, the measurement of disturbance information (step S2) is executed in the period T1 from time t1 to time t2. The level V13s illustrated in FIG. 8 is the level (measurement level of the disturbance information for the heater voltage V13) of the heater voltage V13 at the measurement of the disturbance information. When the level of the heater voltage V13 is set to V13s, the heating temperature of the thermistor 11 and heater 13 becomes 350° C. in the absence of a disturbance. However, when a disturbance such as gas flow is present in measuring atmosphere in this state, the thermistor 11 and heater 13 are cooled by gas flow or the like, and thus the heating temperature of the thermistor 11 and heater 13 decreases to 350° C.-γ. As a result, the detection signal Vdis (disturbance information) changes.

In the example illustrated in FIG. 8, no disturbance is present. Thus, when the level of the detection signal

Vdis (disturbance information) obtained in step S2 indicates a normal level, i.e., a level obtained when the thermistor 11 and heater 13 are heated to 350° C., the heater voltage V13 is applied to the heater 13 in the period T2 from time t3 to time t5. The level of the heater voltage V13 is V13a. When no disturbance is present in the measuring atmosphere, the heating temperature of the thermistor 11 and heater 13 reaches about 150° C. by time t5.

However, when a disturbance such as gas flow is present in measuring atmosphere, the thermistor 11 and heater 13 are cooled by the gas flow or the like, the heating temperature of the thermistor 11 and heater 13 does not reach 150° C. even at time t5. The control circuit 35 increases, according to the level of the detection signal Vdis (disturbance information) obtained in step S2, the application time of the heater voltage V13 to the period T3 (>T2) from time t3 to time t7 so as to make up for such a shortage of the heating time. Thus, even when a disturbance such as gas flow is present in measuring atmosphere, the thermistor 11 and heater 13 are properly heated to about 150° C. Then, by sampling the detection signal Vgas at time t6 immediately before time t7, it is possible to accurately measure gas concentration.

As described above, the gas sensor 200 according to the second embodiment changes the application time of the heater voltage V13 according to the disturbance information to change the heating time of the heater 13. The application time of the heater voltage V13 is determined by the disturbance information. Thus, it is possible to accurately detect CO₂ gas concentration irrespective of the influence of a disturbance in measuring atmosphere.

### Third Embodiment

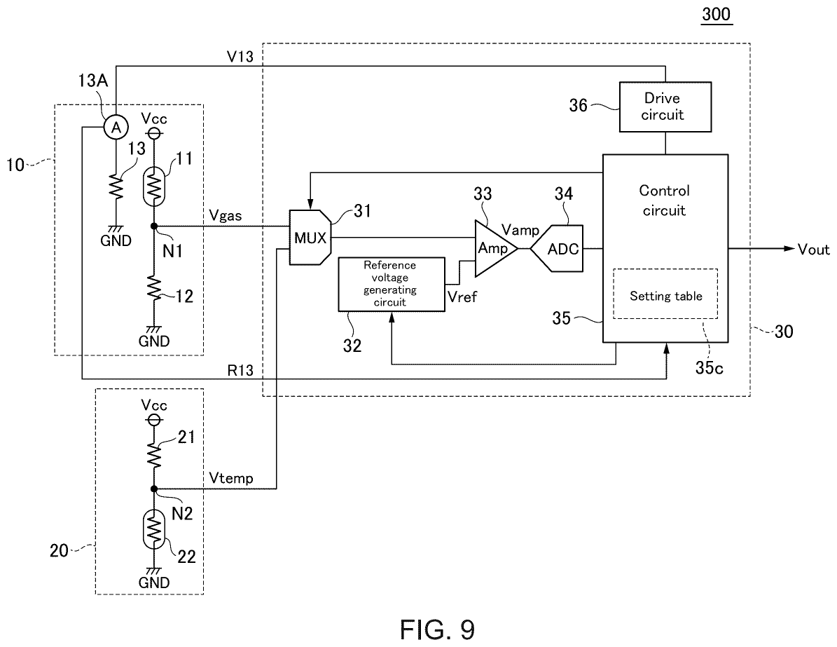

FIG. 9 is a circuit diagram illustrating the configuration of a gas sensor 300 according to a third embodiment of the technology described herein.

As illustrated in FIG. 9, the gas sensor 300 according to the third embodiment differs from the gas sensor 100 according to the first embodiment in that the ammeter 13A is connected in series to the heater 13. Other basic configurations are the same as those of the gas sensor 100 according to the first embodiment, so the same reference numerals are given to the same elements, and overlapping description will be omitted.

The ammeter 13A measures the current value of current flowing through the heater 13 when the heater voltage V13s is applied to the heater 13 in the measurement of disturbance information (step S2). A detection signal R13 output from the ammeter 13A is supplied to the control circuit 35. The control circuit 35 sets the level of the heater voltage V13 based on a current value indicated by the detection signal R13 and heater voltage V13s. The detection signal R13 is disturbance information based on the resistance value of the heater 13 and can be used in place of the detection signal Vdis (disturbance information) that the gas sensor 100 according to the first embodiment obtains in step S2.

That is, when the level of the heater voltage V13 is set to V13s in the absence of a disturbance, the heating temperature of the heater 13 becomes 350° C. However, when a disturbance such as gas flow is present in measuring atmosphere, even if the level of the heater 13 is set to V13s, the heater 13 is cooled by the gas flow, and thus the heating temperature of the heater 13 decreases below 350° C. The resistance value of the heater 13 has temperature dependency, so that when the heating temperature of the heater 13 decreases below 350° C., the resistance value of the heater 13 becomes a value different from that when the heating temperature of the heater 13 is 350° C. (when the heater 13 is made of metal for example, the resistance value thereof becomes lower than that when the heating temperature of the heater 13 is 350° C.). A change thus caused in the current value of current flowing through the heater 13 is measured by the ammeter 13A, whereby the detection signal R13 is generated.

In the same way as the gas sensor 100 according to the first embodiment, the control circuit 35 of the gas sensor 300 according to the third embodiment sets the level of the heater voltage V13 so as to cancel such a decrease in the heating temperature in the measurement of CO₂ gas concentration (step S3). The control circuit 35 performs the level setting for the heater voltage V13 by referring to a setting table 35c included therein. The setting table 35c may be a data table indicating the relationship between the detection signal R13 obtained in the measurement of disturbance information (step S2) and information concerning the heater voltage V13 in the measurement of CO₂ gas concentration (step S3). The information concerning the heater voltage V13 in the measurement of CO₂ gas concentration (step S3) is the same as that in the first embodiment. The gas sensor 300 according to the third embodiment changes, in accordance with the detection signal R13 as the disturbance information, the level of the heater voltage V13 in the measurement period of CO₂ gas concentration to change power applied to the heater 13, thereby changing the heat generation amount of the heater 13.

In the measurement of CO₂ gas concentration (step S3), as is the case with the gas sensor 200 according to the second embodiment, the control circuit 35 may use the setting table 35c to set the application time of the heater voltage V13 so as to cancel the above decrease in the heating temperature. In this case, as the setting table 35c, a data table indicating the relationship between the detection signal R13 obtained in the measurement of disturbance information (step S2) and the application time of the heater voltage V13 in the measurement of CO₂ gas concentration (step S3) is used.

As exemplified by this, the gas sensor 300 according to the third embodiment may use the detection signal R13 based on the resistance value of the heater 13 in the measurement of disturbance information (step S2). Further, the ammeter 13A used for measuring the resistance value of the heater 13 need not be included in the sensor part 10 but may be included in the signal processing circuit 30.

### Fourth Embodiment

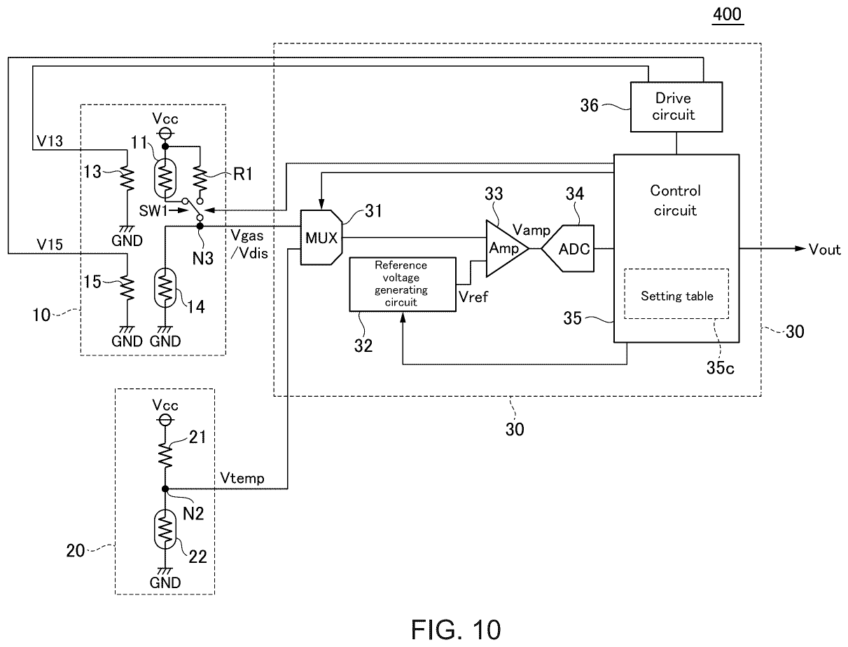

FIG. 10 is a circuit diagram illustrating the configuration of a gas sensor 400 according to a fourth embodiment of the technology described herein.

As illustrated in FIG. 10, the gas sensor 400 according to the fourth embodiment differs from the gas sensor 100 according to the first embodiment in that the sensor part 10 additionally includes a thermistor 14, a heater 15, a resistor R1, and a switch SW1. Other basic configurations are the same as those of the gas sensor 100 according to the first embodiment, so the same reference numerals are given to the same elements, and overlapping description will be omitted.

The thermistors 11 and 14 are connected in series to each other through a switch SW1 between the power supply Vcc and the ground GND. The thermistor 14 is heated by the heater 15. The detection signal Vgas output from the sensor part 10 appears at a node N3 between the thermistors 11 and 14. The thermistor 11 is a temperature-sensitive element for detection, while the thermistor 14 is a temperature-sensitive element for reference. The thermistors 11 and 14 are resistors whose reference value changes with temperature. A heater voltage V15 to be supplied to the heater 15 is supplied by the drive circuit 36, and the level thereof is controlled by the control circuit 35. The resistor R1 is connected in parallel to the thermistor 11. The switch SW1 connects one of the thermistor 11 and resistor R1 to the node N3 under the control of the control circuit 35.

As described above, when CO₂ gas is present in measuring atmosphere in a state where the thermistor 11 as the temperature-sensitive element for detection is heated to a predetermined temperature (e.g., a temperature range around 150° C.) ranging between 100° C. and 230° C. which is a temperature zone exhibiting high CO₂ gas detection sensitivity, heat dissipation characteristics of the thermistor 11 change in accordance with the concentration of the CO₂ gas. This change appears as a change in the temperature of the thermistor 11, i.e., a change in the resistance value thereof. CO₂ gas is lower in heat dissipation than air, so that the temperature of the thermistor 11 increases as the concentration of CO₂ gas increases. Here, assume that heating is performed so that temperature of the thermistor 11 becomes 150° C. in measuring atmosphere where CO₂ gas concentration is, for example, zero. In this case, if CO₂ gas is present in measuring atmosphere, the temperature of the thermistor 11 increases with an increase in the CO₂ gas concentration and exceeds 150° C. As a result, the resistance value of the thermistor 11 lowers as the CO₂ gas concentration in measuring atmosphere increases.

On the other hand, even when CO₂ gas is present in measuring atmosphere in a state where the thermistor 14 as the temperature-sensitive element for reference is heated to a predetermined temperature range (e.g., a temperature range around 300° C.) between 300° C. and 450° C. which is a temperature zone exhibiting low CO₂ gas detection sensitivity, the heat dissipation characteristics of the thermistor 14 hardly change in accordance with the concentration of CO₂ gas, with the result that the temperature of the thermistor 14 hardly changes.

Accordingly, a CO₂ gas concentration-dependent change in the resistance value of the thermistor 14 heated to around 300° C. is sufficiently smaller than a CO₂ gas concentration-dependent change in the resistance value of the thermistor 11 heated to around 150° C. There may be almost no CO₂ gas concentration-dependent change in the resistance value of the thermistor 14 heated to around 300° C. As a result, when the thermistors 11 and 14 are heated to around 150° C. and around 300° C., respectively (when heating is performed so that temperatures of the thermistors 11 and 14 become 150° C. and 300° C., respectively, in measuring atmosphere where CO₂ gas concentration is, for example, zero), the detection signal Vgas corresponding to the concentration of CO₂ gas in measuring atmosphere appears at the node N3 between the thermistors 11 and 14. On the other hand, even when another gas, h there is no significant difference between heat dissipation characteristics exhibited when the thermistor 11 is heated to around 150° C. and those exhibited when the thermistor 14 is heated to around 300° C., is contained in measuring atmosphere, the concentration of this gas has little influence on the detection signal Vgas. This allows the sensor part 10 to selectively detect the concentration of CO₂ gas.

However, when a disturbance such as gas flow is present in measuring atmosphere, the thermistors 11 and 14 are cooled by the gas flow or the like, and thus the heating temperatures thereof decrease. Thus, as the flow velocity increases, the heating temperature of the thermistor 11 decreases as denoted by the arrow A in FIG. 2, so that the heating temperature of the thermistor 11 becomes less than 150° C. to lower the detection sensitivity. As a result, the change amount of the detection signal Vgas with respect to a change in CO₂ gas concentration decreases. Further, for example, as the flow velocity increases, the heating temperature of the thermistor 14 decreases as denoted by the arrow B in FIG. 2, so that the heating temperature of the thermistor 14 becomes less than 300° C. to increase the detection sensitivity. As a result, a change occurs in the resistance value of the thermistor 14 depending on the concentration of CO₂ gas. This also reduces the change amount of the detection signal Vgas with respect to a change in CO₂ gas concentration. As described above, when a disturbance such as gas flow is present in measuring atmosphere, the detection signal Vgas changes due to a disturbance.

The operation of the gas sensor 400 according to the present embodiment is as illustrated in the flowchart of FIG. 4. For example, before execution of the measurement of CO₂ gas concentration (step S3), the measurement of environmental temperature (step S1) and measurement of disturbance information (step S2) are executed.

In the measurement of disturbance information (step S2), the control circuit 35 connects the switch SW1 to the resistor R1 side. In this state, the heater voltage V15 is set to the measurement level of disturbance information, whereby the thermistor 14 and heater 15 are heated to a predetermined temperature range (e.g., a temperature range around 350° C.) between 320° C. and 450° C. In the measurement of CO₂ gas concentration (step S3), the control circuit 35 connects the switch SW1 to the thermistor 11 side. In this state, the thermistor 11 and heater 13 are heated to a predetermined temperature range (e.g., a temperature range around 150° C.) between 100° C. and 230° C., and the thermistor 14 and heater 15 are heated to a predetermined temperature range (e.g., a temperature range around 300° C.) between 300° C. and 450° C. (the thermistors 11 and 14 are heated to, for example, 150° C. and 300° C., respectively, when CO₂ gas concentration in measuring atmosphere is, for example, zero). Then, in the measurement of CO₂ gas concentration (step S3), the control circuit 35 sets the levels of the heater voltages V13 and V15 so as to cancel a decrease in the heating temperature caused due to a disturbance. The level setting of the heater voltage V15 in the measurement of CO₂ gas concentration (step S3) is performed in the same way as for the heater voltage V13.

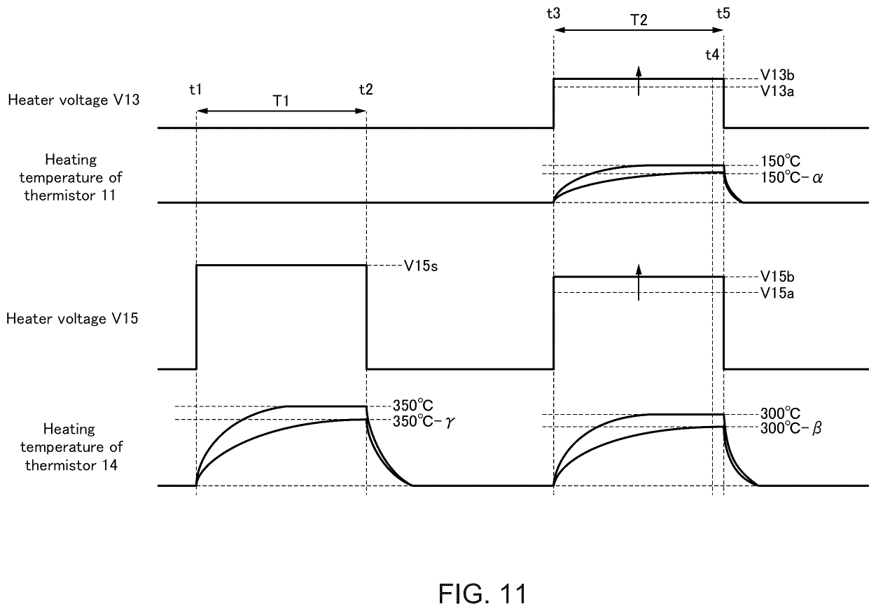

FIG. 11 is a timing chart for explaining a first setting method in the fourth embodiment.

In the example illustrated in FIG. 11, the measurement of disturbance information (step S2) is executed in the period T1 from time t1 to time t2. In the period T1, the heater voltage V13 is not applied, while the level of the heater voltage V15 is set to V15s. The level V15s illustrated in FIG. 11 is the level (measurement level of the disturbance information for the heater voltage V15) of the heater voltage V15 at the measurement of the disturbance information. When the level of the heater voltage V15 is set to V15s, the heating temperature of the thermistor 14 and heater 15 becomes 350° C. in the absence of a disturbance. However, when a disturbance such as gas flow is present in measuring atmosphere, even if the level of the heater voltage V15 is set to V15s, the thermistor 14 and heater 15 are cooled by gas flow or the like, and thus the heating temperature of the thermistor 14 and heater 15 decreases to 350° C.-γ. As a result, the detection signal Vdis (disturbance information) changes. The detection signal Vdis obtained in the measurement of disturbance information (step S2) is disturbance information based on the resistance value of the thermistor 14.

In the example illustrated in FIG. 11, the measurement of CO₂ gas concentration (step S3) is executed in the period T2 from time t3 to time t5. The level V13a illustrated in FIG. 11 is the level of the heater voltage V13 in the absence of a disturbance, for example, when gas flow velocity in measuring atmosphere is zero, and the level V15a illustrated in FIG. 11 is the level of the heater voltage V15 in the absence of a disturbance, for example, when gas flow velocity in measuring atmosphere is zero. That is, when the levels of the heater voltages V13 and V15 are set to V13a and V15a, respectively, in the absence of a disturbance, the heating temperature of the thermistor 11 and heater 13 becomes about 150° C., and the heating temperature of the thermistor 14 and heater 15 becomes about 300° C.

However, in a case where a disturbance such as gas flow is present in measuring atmosphere, when the levels of the heater voltages V13 and V15 are set to V13a and V15a, respectively, the thermistors 11 and 14 are cooled by the disturbance. Therefore, when CO₂ gas concentration in measuring atmosphere is, for example, zero, the heating temperature of the thermistor 11 and heater 13 decreases to 150° C.-α, not 150° C., and heating temperature of the thermistor 14 and heater 15 decreases to 300° C.-β, not 300° C. The control circuit 35 sets the levels of the heater voltages V13 and V15 to V13b (>V13a) and V15b (>V15a), respectively, in accordance with the disturbance information obtained in step S2 so as to cancel such a decrease in the heating temperature.

That is, the control circuit 35 changes, in accordance with the detection signal Vdis as the disturbance information, the levels of the heater voltages

V13 and V15 in the measurement period of CO₂ gas concentration to change power applied to the heaters 13 and 15, thereby changing the heat generation amounts of the heaters 13 and 15. Further, the difference in heat dissipation characteristics between CO₂ gas (gas to be detected) and air in a temperature range (first temperature range) around 350° C. is smaller than that in a temperature range (third temperature range) around 150° C., and the difference in heat dissipation characteristics between CO₂ gas (gas to be detected) and air in a temperature range (second temperature range) around 300° C. is smaller than that in a temperature range (third temperature range) around 150° C., so that, in the gas sensor 400 according to the fourth embodiment, the sensitivity of the thermistor 14 with respect to CO₂ gas (gas to be detected) in the temperature range (first temperature range) around 350° C. is lower than the sensitivity of the thermistor 11 with respect to CO₂ gas (gas to be detected) in the temperature range (third temperature range) around 150° C., and the sensitivity of the thermistor 14 with respect to CO₂ gas (gas to be detected) in the temperature range (second temperature range) around 300° C. is lower than the sensitivity of the thermistor 11 with respect to CO₂ gas (gas to be detected) in the temperature range (third temperature range) around 150° C. The first temperature range which is a predetermined temperature range (in this example, a temperature range around 350° C.) between 320° C. and 450° C. differs from the third temperature range which is a predetermined temperature range (in this example, a temperature range around 150° C.) between 100° C. and 230° C. and is higher in temperature than the third temperature range. The second temperature range which is a predetermined temperature range (in this example, a temperature range around 300° C.) between 300° C. and 450° C. differs from the third temperature range which is a predetermined temperature range (in this example, a temperature range around 150° C.) between 100° C. and 230° C. and is higher in temperature than the third temperature range. Thus, even in a case where a disturbance such as gas flow is present in measuring atmosphere, when CO₂ gas concentration in measuring atmosphere is, for example, zero, the thermistor 11 and heater 13 are properly heated to 150° C., and the thermistor 14 and heater 15 are properly heated to 300° C. Then, by sampling the detection signal Vgas at time t4 immediately before time t5, it is possible to accurately measure gas concentration.

Although, in the fourth embodiment, the thermistor 14 is heated to the second temperature range (temperature range around 300° C.) different from the first temperature range (temperature range around 350° C.) in the measurement of CO₂ gas concentration (step S3), the first and second temperature ranges may be the same. That is, for example, the thermistor 14 may be heated to a temperature range around 350° C. in the measurement of CO₂ gas concentration (step S3).

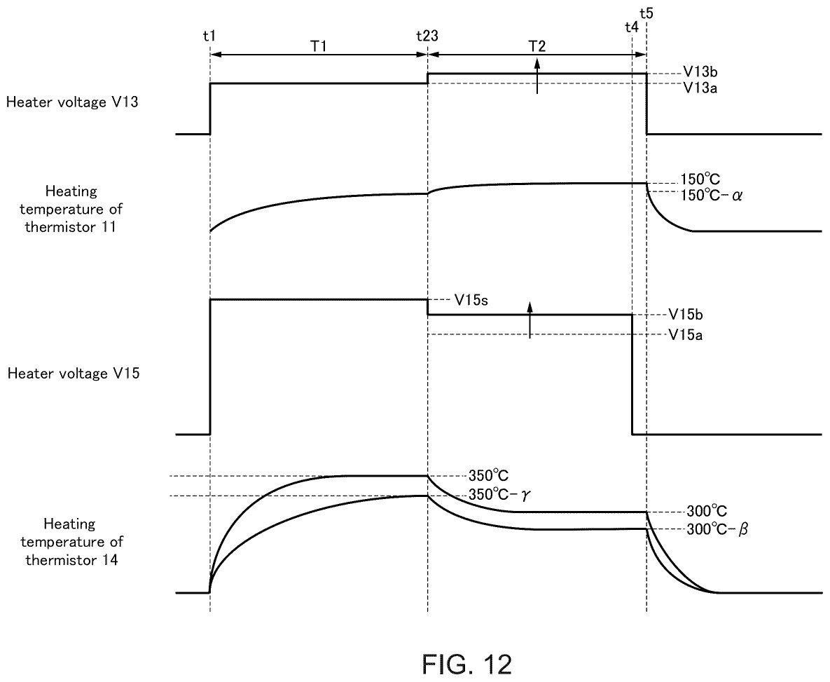

FIG. 12 is a timing chart for explaining a second setting method in the fourth embodiment.

In the example illustrated in FIG. 12, the period from time t2 to time t3 illustrated in FIG. 11 is omitted, and thus the periods T1 and T2 are successively executed. That is, the measurement of disturbance information (step S2) is executed in the period T1 from time t1 to time t23, and the measurement of CO₂ gas concentration (step S3) is executed in the period T2 from time t23 to time t5. In the period T1, the level of the heater voltage V13 may be set to V13a.

By thus successively executing the periods T1 and T2 and by setting the level of the heater voltage V13 to V13a in the period T1, residual heat in the period T1 can be utilized, thus reducing a time required for the period T2.

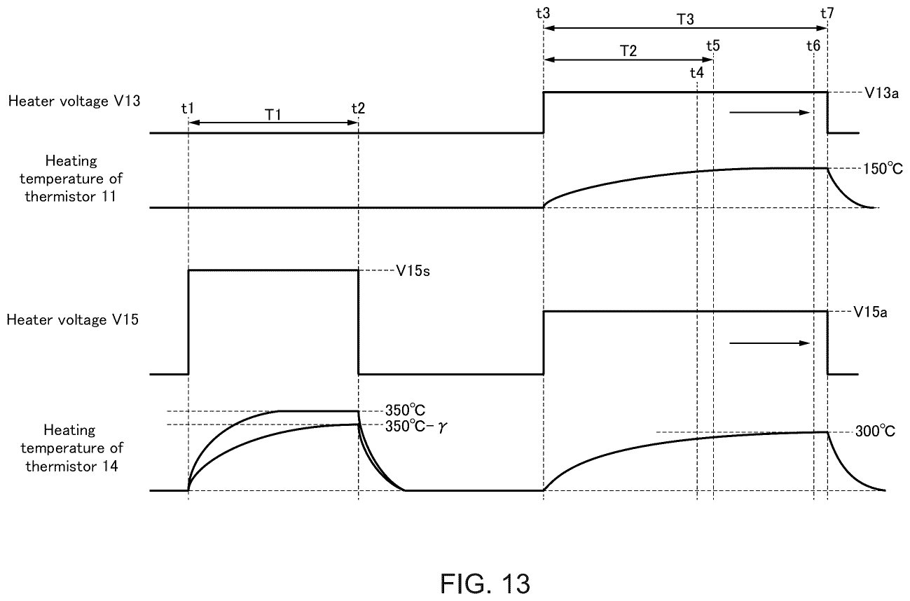

FIG. 13 is a timing chart for explaining a third setting method in the fourth embodiment.

In the example illustrated in FIG. 13, the measurement of disturbance information (step S2) is executed in the period T1 from time t1 to time t2. In the period T1, the heater voltage V13 is not applied, while the level of the heater voltage V15 is set to V15s. When the level of the heater voltage V15 is set to V15s, the heating temperature of the thermistor 14 and heater 15 becomes 350° C. in the absence of a disturbance. However, when a disturbance such as gas flow is present in measuring atmosphere, even if the level of the heater voltage V15 is set to V15s, the thermistor 14 and heater 15 are cooled by gas flow or the like, and thus the heating temperature of the thermistor 14 and heater 15 decreases to 350° C.-γ. As a result, the detection signal Vdis (disturbance information) changes.

In the example illustrated in FIG. 13, no disturbance is present. Thus, when the level of the detection signal Vdis (disturbance information) obtained in step S2 indicates a normal level, i.e., a level obtained when the thermistor 14 and heater 15 are heated to 350° C., the heater voltages V13 and V15 are applied to the heaters 13 and 15, respectively, in the period T2 from time t3 to time t5.

The levels of the heater voltages V13 and V15 are set based on information (amplified signal Vamp of the temperature signal Vtemp) concerning environmental temperature and are V13a and V15a, respectively. When no disturbance is present in the measuring atmosphere, the heating temperature of the thermistor 11 and heater 13 reaches about 150° C. by time t5, and the heating temperature of the thermistor 14 and heater 15 reaches about 300° C. by time t5.

However, when a disturbance such as gas flow is present in measuring atmosphere, the thermistors 11, 14 and heaters 13, 15 are cooled by the gas flow or the like, and the heating temperature of the thermistor 11 and heater 13 therefore does not reach 150° C. even at time t5, and the heating temperature of the thermistor 14 and heater 15 does not reach 300° C. even at time t5. The control circuit 35 increases, according to the level of the detection signal Vdis (disturbance information) obtained in step S2, the application times of the heater voltages V13 and V15 to the period T3 (>T2) from time t3 to time t7 so as to make up for such a shortage of the heating time. Thus, even when a disturbance such as gas flow is present in measuring atmosphere, the thermistor 11 and heater 13 are properly heated to about 150° C., and the thermistor 14 and heater 15 are properly heated to about 300° C. Then, by sampling the detection signal Vgas at time t6 immediately before time t7, it is possible to accurately measure gas concentration.

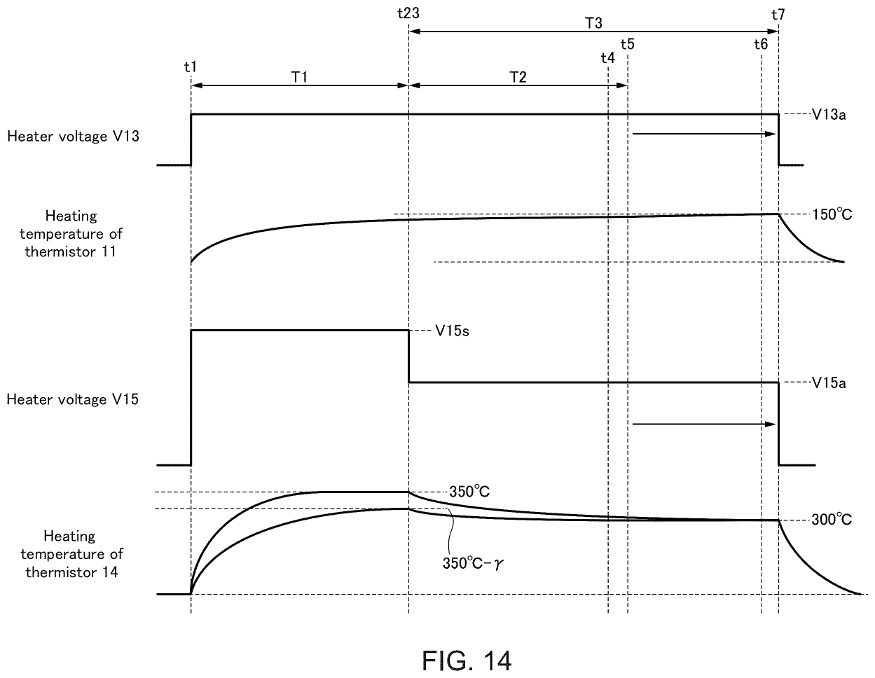

FIG. 14 is a timing chart for explaining a fourth setting method in the fourth embodiment.

In the example illustrated in FIG. 14, the period from time t2 to time t3 illustrated in FIG. 13 is omitted, and thus the periods T1 and T2 are successively executed. That is, the measurement of disturbance information (step S2) is executed in the period T1 from time t1 to time t23, and the measurement of CO₂ gas concentration (step S3) is executed in the period T2 from time t23 to time t5 or in the period T3 from time t23 to time t7. In the period T1, the level of the heater voltage V13 may be set to V13a.

By thus successively executing the periods T1 and T2 and by setting the level of the heater voltage V13 to V13a in the period T1, residual heat in the period T1 can be utilized, thus reducing a time required for the periods T2 and T3.

### Fifth Embodiment

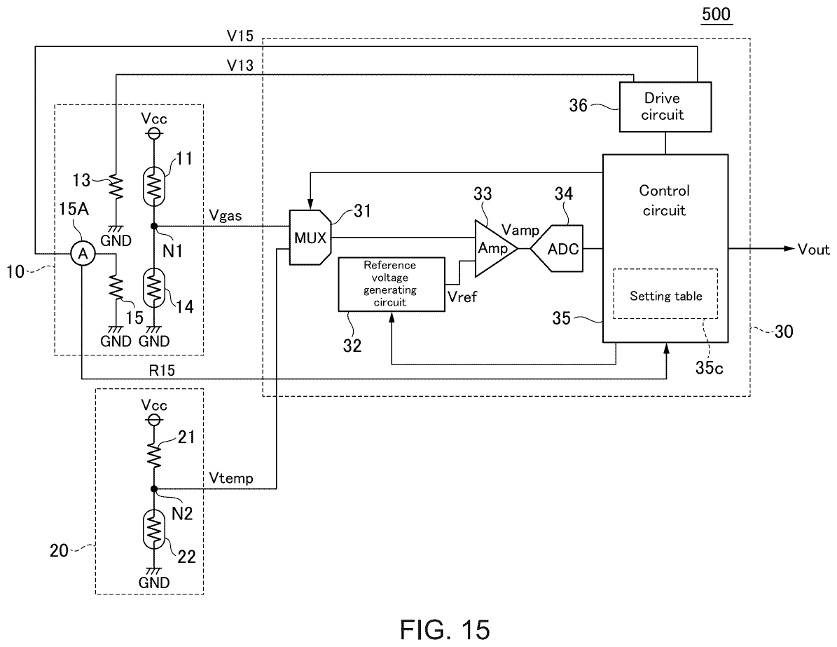

FIG. 15 is a circuit diagram illustrating the configuration of a gas sensor 500 according to a fifth embodiment of the technology described herein.

As illustrated in FIG. 15, the gas sensor 500 according to the fifth embodiment differs from the gas sensor 400 according to the fourth embodiment in that an ammeter 15A is connected in series to the heater 15 and that the resistor R1 and switch SW1 are omitted. Other basic configurations are the same as those of the gas sensor 400 according to the fourth embodiment, so the same reference numerals are given to the same elements, and overlapping description will be omitted.

The ammeter 15A measures the current value of current flowing through the heater 15 when the heater voltage V15s is applied to the heater 15 in the measurement of disturbance information (step S2). A detection signal R15 output from the ammeter 15A is supplied to the control circuit 35. The control circuit 35 sets the levels of the heater voltages V13 and V15 based on a current value indicated by the detection signal R15 and heater voltage V15s. The detection signal R15 is disturbance information based on the resistance value of the heater 15 and can be used in place of the detection signal Vdis (disturbance information) that the gas sensor 400 according to the fourth embodiment obtains in step S2.

As exemplified by this, the gas sensor 500 according to the fifth embodiment may use the detection signal R15 based on the resistance value of the heater 15 in the measurement of disturbance information (step S2).

### Sixth Embodiment

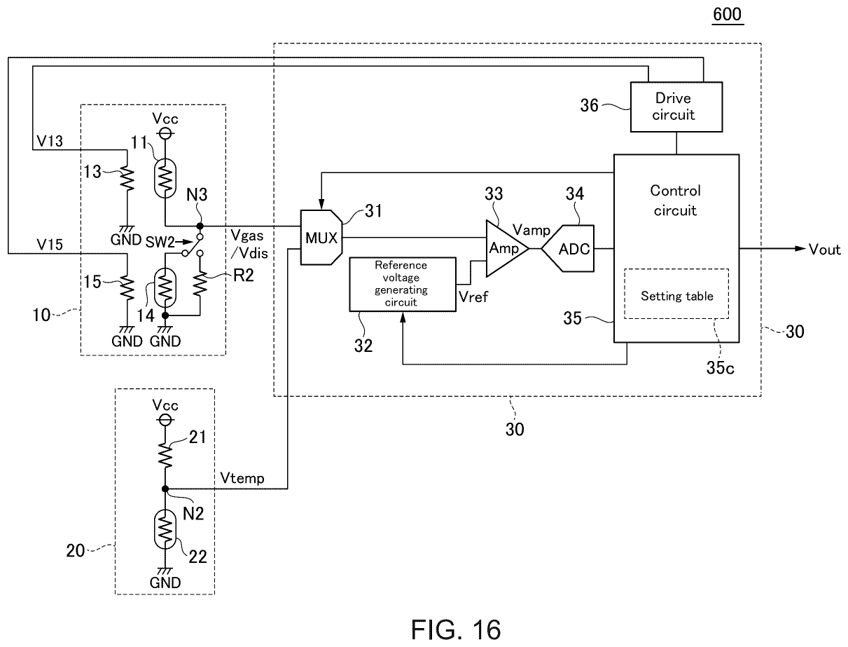

FIG. 16 is a circuit diagram illustrating the configuration of a gas sensor 600 according to a sixth embodiment of the technology described herein.

As illustrated in FIG. 16, the gas sensor 600 according to the sixth embodiment differs from the gas sensor 400 according to the fourth embodiment in that a resistor R2 and a switch SW2 are used in place of the resistor R1 and switch SW1. The resistor R2 is connected in parallel to the thermistor 14. The switch SW2 connects one of the thermistor 14 and resistor R2 to the node N3 under the control of the control circuit 35. Other basic configurations are the same as those of the gas sensor 400 according to the fourth embodiment, so the same reference numerals are given to the same elements, and overlapping description will be omitted.

In the measurement of disturbance information (step S2), the control circuit 35 connects the switch SW2 to the resistor R2 side. In this state, the heater voltage V13 is set to the measurement level of disturbance information, whereby the thermistor 11 and heater 13 are heated to a predetermined temperature range (e.g., a temperature range around 350° C.) between 320° C. and 450° C. In the measurement of CO₂ gas concentration (step S3), the control circuit 35 connects the switch SW2 to the thermistor 14 side. In this state, the thermistor 11 and heater 13 are heated to a predetermined temperature range (e.g., a temperature range around 150° C.) between 100° C. and 230° C. which is a temperature zone exhibiting high CO₂ gas detection sensitivity, and the thermistor 14 and heater 15 are heated to a predetermined temperature range (e.g., a temperature range around 300° C.) between 300° C. and 450° C. which is a temperature zone exhibiting low CO₂ gas detection sensitivity (the thermistors 11 and 14 are heated to, for example, 150° C. and 300° C., respectively, when CO₂ gas concentration in measuring atmosphere is, for example, zero). Then, in the measurement of CO₂ gas concentration (step S3), the control circuit 35 sets the levels of the heater voltages V13 and V15 so as to cancel a decrease in the heating temperature caused due to a disturbance.

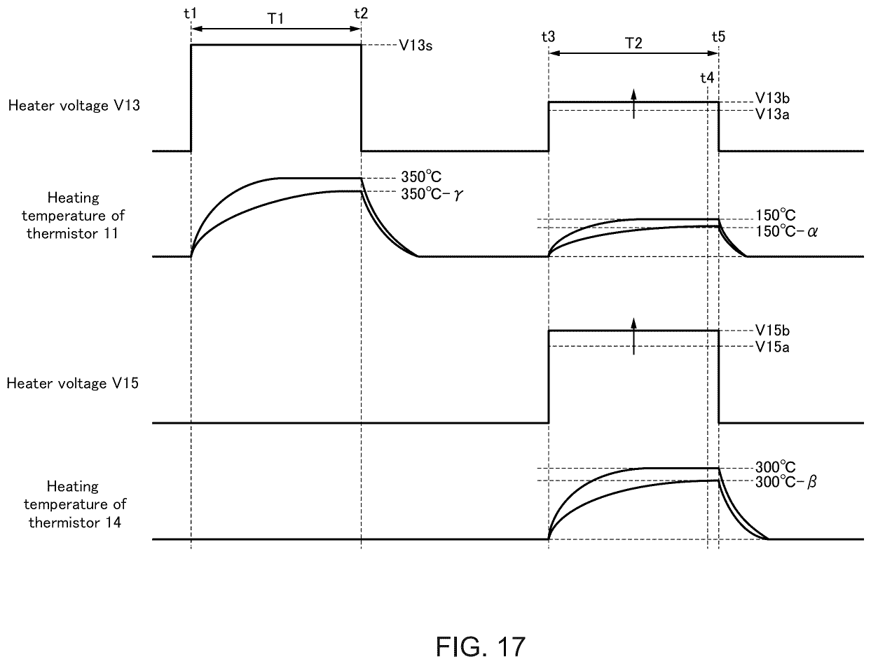

FIG. 17 is a timing chart for explaining a first setting method in the sixth embodiment.

In the example illustrated in FIG. 17, the measurement of disturbance information (step S2) is executed in the period T1 from time t1 to time t2. In the period T1, the heater voltage V15 is not applied, while the level of the heater voltage V13 is set to V13s. When the level of the heater voltage V13 is set to V13s, the heating temperature of the thermistor 11 and heater 13 becomes 350° C. in the absence of a disturbance. However, when a disturbance such as gas flow is present in measuring atmosphere, even if the level of the heater voltage V13 is set to V13s, the thermistor 11 and heater 13 are cooled by gas flow or the like, and thus the heating temperature of the thermistor 11 and heater 13 decreases to 350° C.-γ. As a result, the detection signal Vdis (disturbance information) changes.

In the example illustrated in FIG. 17, the measurement of CO₂ gas concentration (step S3) is executed in the period T2 from time t3 to time t5. In a case where a disturbance such as gas flow is present in measuring atmosphere, when the levels of the heater voltages V13 and

V15 are set to V13a and V15a, respectively, the thermistors 11, 14 and heaters 13, 15 are cooled by the disturbance. Therefore, when CO₂ gas concentration in measuring atmosphere is, for example, zero, the heating temperature of the thermistor 11 and heater 13 decreases to 150° C.-α, not 150° C. and the heating temperature of the thermistor 14 and heater 15 decreases to 300° C.-β, not 300° C. The control circuit 35 sets the levels of the heater voltages V13 and V15 to V13b (>V13a) and V15b (>V15a), respectively, in accordance with the disturbance information obtained in step S2 so as to cancel such a decrease in the heating temperature.

That is, the control circuit 35 changes, in accordance with the detection signal Vdis as the disturbance information, the levels of the heater voltages

V13 and V15 in the measurement period of CO₂ gas concentration, to change power applied to the heaters 13 and 15, thereby changing the heat generation amounts of the heaters 13 and 15. Further, the difference in heat characteristics between CO₂ gas (gas to be dissipation detected) and air in a temperature range (first temperature range) around 350° C. is smaller than that in a temperature range (second temperature range) around 150° C., and the difference in heat dissipation characteristics between CO₂ gas (gas to be detected) and air in a temperature range (third temperature range) around 300° C. is smaller than that in a temperature range (second temperature range) around 150° C., so that, in the gas sensor 600 according to the sixth embodiment, the sensitivity of the thermistor 11 with respect to CO₂ gas (gas to be detected) in the temperature range (first temperature range) around 350° C. is lower than the sensitivity of the thermistor 11 with respect to CO₂ gas (gas to be detected) in the temperature range (second temperature range) around 150° C., and the sensitivity of the thermistor 14 with respect to CO₂ gas (gas to be detected) in the temperature range (third temperature range) around 300° C. is lower than the sensitivity of the thermistor 11 with respect to CO₂ gas (gas to be detected) in the temperature range (second temperature range) around 150° C.

The first temperature range which is a predetermined temperature range (in this example, a temperature range around 350° C.) between 320° C. and 450° C. differs from the second temperature range which is a predetermined temperature range (in this example, a temperature range around 150° C.) between 100° C. and 230° C. and is higher in temperature than the second temperature range. The third temperature range which is a predetermined temperature range (in this example, a temperature range around 300° C.) between 300° C. and 450° C. differs from the second temperature range which is a predetermined temperature range (in this example, a temperature range around 150° C.) between 100° C. and 230° C. and is higher in temperature than the third temperature range. Thus, even in a case where a disturbance such as gas flow is present in measuring atmosphere, when CO₂ gas concentration in measuring atmosphere is, for example, zero, the thermistor 11 and heater 13 are properly heated to 150° C., and the thermistor 14 and heater 15 are properly heated to 300° C. Then, by sampling the detection signal Vgas at time t4 immediately before time t5, it is possible to accurately measure gas concentration.

Although, in the sixth embodiment, the thermistor 14 is heated to the third temperature range (temperature range around 300° C.) different from the first temperature range (temperature range around 350° C.) in the measurement of CO₂ gas concentration (step S3), the first and third temperature ranges may be the same. That is, for example, the thermistor 14 may be heated to a temperature range around 350° C. in the measurement of CO₂ gas concentration (step S3).

In the example illustrated in FIG. 17 as well, the periods T1 and T2 may be successively executed with the period from time t2 to time t3 omitted, as described using FIG. 12.

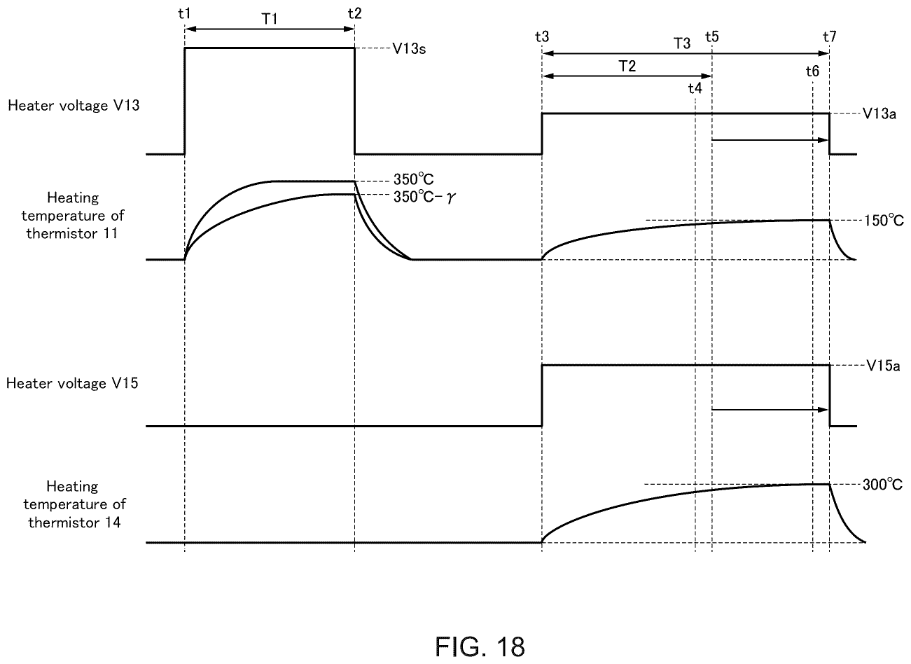

FIG. 18 is a timing chart for explaining a second setting method in the sixth embodiment.

In the example i illustrated in FIG. 18, the measurement of disturbance information (step S2) is executed in the period T1 from time t1 to time t2. In the period T1, the heater voltage V15 is not applied, while the level of the heater voltage V13 is set to V13s. When the level of the heater voltage V13 is set to V13s, the heating temperature of the thermistor 11 and heater 13 becomes 350° C. in the absence of a disturbance. However, when a disturbance such as gas flow is present in measuring atmosphere, even if the level of the heater voltage V13 is set to V13s, the thermistor 11 and heater 13 are cooled by gas flow or the like, and thus the heating temperature of the thermistor 11 and heater 13 decreases to 350° C.-γ. As a result, the detection signal Vdis (disturbance information) changes.

In the example illustrated in FIG. 18, no disturbance is present. Thus, when the level of the detection signal Vdis (disturbance information) obtained in step S2 indicates a normal level, i.e., a level obtained when the thermistor 11 and heater 13 are heated to 350° C., the heater voltages V13 and V15 are applied to the heaters 13 and 15, respectively, in the period T2 from time t3 to time t5. The levels of the heater voltages V13 and V15 are set based on information (amplified signal Vamp of the temperature signal Vtemp) concerning environmental temperature and are V13a and V15a, respectively. When no disturbance is present in the measuring atmosphere, the heating temperature of the thermistor 11 and heater 13 reaches about 150° C. by time t5, and the heating temperature of the thermistor 14 and heater 15 reaches about 300° C. by time t5.

However, when a disturbance such as gas flow is present in measuring atmosphere, the thermistors 11, 14 and heaters 13, 15 are cooled by the gas flow or the like, the heating temperature of the thermistor 11 and heater 13 does not reach 150° C. even at time t5, and the heating temperature of the thermistor 14 and heater 15 does not reach 300° C. even at time t5. The control circuit 35 increases, according to the level of the detection signal Vdis (disturbance information) obtained in step S2, the application times of the heater voltages V13 and V15 to the period T3 (>T2) from time t3 to time t7 so as to make up for such a shortage of the heating time. Thus, even when a disturbance such as gas flow is present in measuring atmosphere, the thermistor 11 and heater 13 are properly heated to about 150° C., and thermistor 14 and heater 15 are properly heated to about 300° C. Then, by sampling the detection signal Vgas at time t6 immediately before time t7, it is possible to accurately measure gas concentration.

In the example illustrated in FIG. 18 as well, the periods T1 and T2 may be successively executed with the period from time t2 to time t3 omitted, as described using FIG. 14.

### Seventh Embodiment

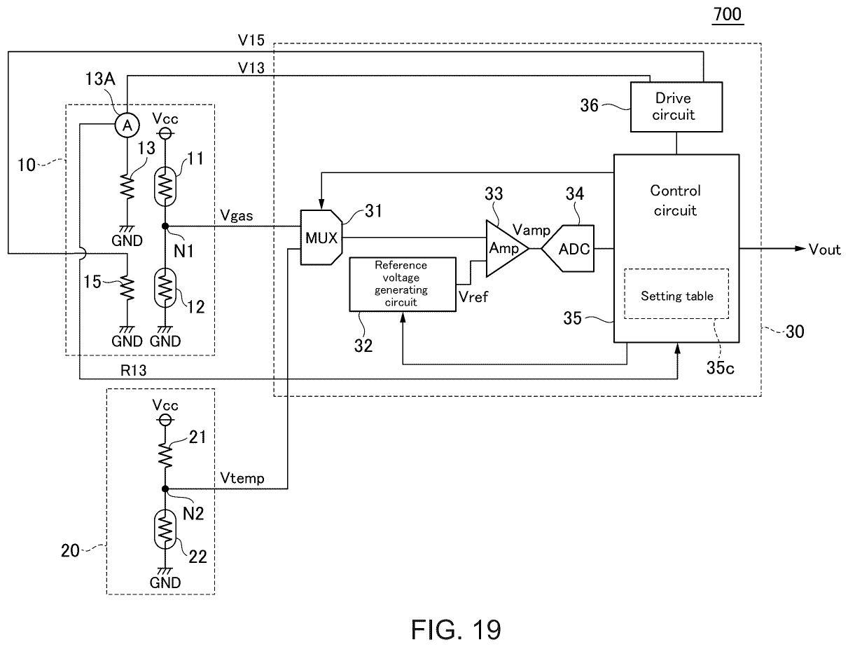

FIG. 19 is a circuit diagram illustrating the configuration of a gas sensor 700 according to a seventh embodiment of the technology described herein.

As illustrated in FIG. 19, the gas sensor 700 according to the seventh embodiment differs from the gas sensor 600 according to the sixth embodiment in that an ammeter 13A is connected in series to the heater 13 and that the resistor R2 and switch SW2 are omitted. Other basic configurations are the same as those of the gas sensor 600 according to the sixth embodiment, so the same reference numerals are given to the same elements, and overlapping description will be omitted.

The ammeter 13A measures the current value of current flowing through the heater 13 when the heater voltage V13s is applied to the heater 13 in the measurement of disturbance information (step S2). The detection signal R13 output from the ammeter 13A is supplied to the control circuit 35. The control circuit 35 sets the levels of the heater voltages V13 and V15 based on a current value indicated by the detection signal R13 and heater voltage V13s. The detection signal R13 is disturbance information based on the resistance value of the heater 13 and can be used in place of the detection signal Vdis (disturbance information) that the gas sensor 600 according to the sixth embodiment obtains in step S2.

### Eighth Embodiment

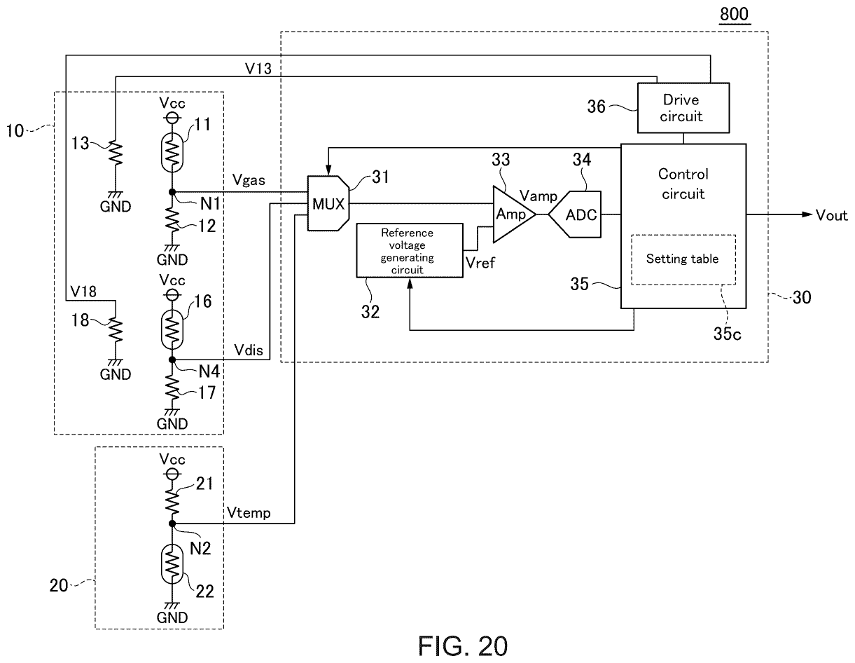

FIG. 20 is a circuit diagram illustrating the configuration of a gas sensor 800 according to an eighth embodiment of the technology described herein.

As illustrated in FIG. 20, the gas sensor 800 according to the eighth embodiment differs from the gas sensor 100 according to the first embodiment in that the sensor part 10 additionally includes a thermistor 16, a resistor 17, and a heater 18. Other basic configurations are the same as those of the gas sensor 100 according to the first embodiment, so the same reference numerals are given to the same elements, and overlapping description will be omitted.

The thermistor 16 and resistor 17 are connected in series to each other between the power supply Vcc and the ground GND. The thermistor 16 is heated by the heater 18. The disturbance signal Vdis output from the sensor part 10 appears at a node N4 between the thermistor 16 and the resistor 17. A heater voltage V18 to be supplied to the heater 18 is supplied by the drive circuit 36, and the level thereof is controlled by the control circuit 35.

The operation of the gas sensor 800 according to the present embodiment is as illustrated in the flowchart of FIG. 4. For example, before execution of the measurement of CO₂ gas concentration (step S3), the measurement of environmental temperature (step S1) and measurement of disturbance information (step S2) are executed.

In the measurement of disturbance information (step S2), the multiplexer 31 selects the disturbance signal Vdis. In this state, the thermistor 16 and heater 18 are heated to a temperature range around 350° C., for example. As described above, when the heater voltage V18 is adjusted so that the thermistor 16 and heater 18 are heated to 350° C., for example, without consideration of a disturbance which may affect the measurement of CO₂ gas concentration, the heating temperature of the thermistor 16 and heater 18 does not reach 350° C. in a state where the disturbance is actually present. As a result, the disturbance signal Vdis has a level different from that when the thermistor 16 and heater 18 are properly heated to 350° C. The disturbance signal Vdis obtained in the measurement of disturbance information (step S2) is disturbance information based on the resistance value of the thermistor 16. The control circuit 35 sets the level of the heater voltage V13 or the heating time of the heater 13 in the measurement of CO₂ gas concentration (step S3) so as to cancel a decrease in the heating temperature caused due to a disturbance. The difference in heat dissipation characteristics between CO₂ gas (gas to be detected) and air in a temperature range (first temperature range) around 350° C. is smaller than that in a temperature range (second temperature range) around 150° C., so that, in the gas sensor 800 according to the eighth embodiment, the sensitivity of the thermistor 16 with respect to CO₂ gas (gas to be detected) in the temperature range (first temperature range) around 350° C. is lower than the sensitivity of the thermistor 11 with respect to CO₂ gas (gas to be detected) in the temperature range (second temperature range) around 150° C. The first temperature range which is a predetermined temperature range (in this example, a temperature range around 350° C.) between 320° C. and 450° C. differs from the second temperature range which is a predetermined temperature range (in this example, a temperature range around 150° C.) between 100° C. and 230° C. and is higher in temperature than the second temperature range. This makes it possible to accurately measure gas concentration.

As exemplified by this, the gas sensor 800 according to the eighth embodiment may use a thermistor different from that used for measurement of CO₂ gas concentration to detect the disturbance information. This prevents a heat load from being applied to the thermistor 11 for measurement of CO₂ gas concentration in the measurement of disturbance information (step S2), thus making it possible to reduce drift due to a heat load.

### Nineth Embodiment

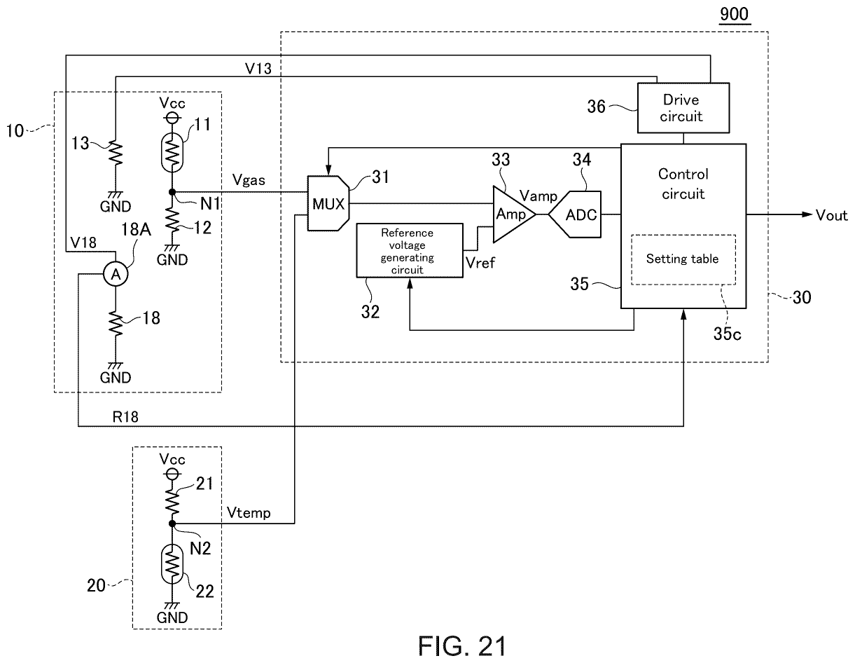

FIG. 21 is a circuit diagram illustrating the configuration of a gas sensor 900 according to a ninth embodiment of the technology described herein.

As illustrated in FIG. 21, the gas sensor 900 according to the ninth embodiment differs from the gas sensor 800 according to the eighth embodiment in that an ammeter 18A is connected in series to the heater 18 and that the thermistor 16 and resistor 17 are omitted. Other basic configurations are the same as those of the gas sensor 800 according to the eighth embodiment, so the same reference numerals are given to the same elements, and overlapping description will be omitted.

The ammeter 18A measures the current value of current flowing through the heater 18 when the heater voltage V18 is applied to the heater 18 in the measurement of disturbance information (step S2). A detection signal R18 from the ammeter 18A is supplied to the control output circuit 35. The control circuit 35 sets the level of the heater voltage V13 or the heating time of the heater 13 based on a current value indicated by the detection signal R18 and heater voltage V18. The difference in heat dissipation characteristics between CO₂ gas (gas to be detected) and air in a temperature range (first temperature range) around 350° C. is smaller than that in a temperature range (second temperature range) around 150° C., so that, in the gas sensor 900 according to the ninth embodiment, the sensitivity of the heater 18 with respect to CO₂ gas (gas to be detected) in the temperature range (first temperature range) around 350° C. is lower than the sensitivity of the thermistor 11 (temperature-sensitive element) with respect to CO₂ gas (gas to be detected) in the temperature range (second temperature range) around 150° C. Further, for the same reason, in the gas sensor 900 according to the ninth embodiment, the sensitivity of the thermistor 11 (temperature-sensitive element) with respect to CO₂ gas (gas to be detected) in the temperature range (first temperature range) around 350° C. is lower than the sensitivity of the thermistor 11 with respect to CO₂ gas (gas to be detected) in the temperature range (second temperature range) around 150° C. The first temperature range which is a predetermined temperature range (in this example, a temperature range around 350° C.) between 320° C. and 450° C. differs from the second temperature range which is a predetermined temperature range (in this example, a temperature range around 150° C.) between 100° C. and 230° C. and is higher in temperature than the second temperature range. The detection signal R18 is disturbance information based on the resistance value of the heater 18 and can be used in place of the disturbance signal Vdis (disturbance information) that the gas sensor 800 according to the eighth embodiment obtains in step S2.

As exemplified by this, the gas sensor 900 according to the ninth embodiment may detect the disturbance information using the heater and ammeter without the use of the thermistor.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although a thermistor serving as a resistor is used as a temperature-sensitive element of the sensor part 10 in the above embodiments, the present invention is not limited to this. For example, platinum (Pt) or tungsten (W) serving as a resistor may be used as the temperature-sensitive element.

Further, the level of the heater voltage V13 is changed in accordance with the disturbance information in the first embodiment, and the application time of the heater voltage V13 is changed in accordance with the disturbance information; however, both the level and application time of the heater voltage V13 may be changed in accordance with the disturbance information.

The technology according to the present disclosure includes the following configuration examples, but not limited thereto.

A gas sensor according to an aspect of the present disclosure includes: a sensor part configured to generate a detection signal indicating the concentration of a gas to be detected; and a control circuit configured to calculate the concentration of the gas to be detected based on the detection signal, wherein the sensor part includes a first temperature-sensitive element and a first heater configured to heat the first temperature-sensitive element, and the control circuit is configured to obtain, in a disturbance information measurement period, disturbance information based on the resistance value of the first temperature-sensitive element or the resistance value of the first heater in a state where the first temperature-sensitive element is heated to a first temperature range by the first heater and obtain, in a gas concentration measurement period, the detection signal by heating the first temperature-sensitive element to a second temperature range by the first heater under a heating condition corresponding to the disturbance information. This makes it possible to accurately detect gas concentration irrespective of the influence of a disturbance in measuring atmosphere.

In the above gas sensor, the sensitivity of the first temperature-sensitive element with respect to the gas to be detected in the first temperature range may be lower than the sensitivity of the first temperature-sensitive element with respect to the gas to be detected in the second temperature range. This makes it possible to accurately measure the influence of a disturbance in measuring atmosphere irrespective of the concentration of the gas to be detected.

In the above gas sensor, the sensor part may further include a second temperature-sensitive element and a second heater that heats the second temperature-sensitive element, the first and second temperature-sensitive elements may be connected in series to each other, the detection signal may appear at a node between the first and second temperature-sensitive elements, and the control circuit may be configured to heat, in the gas concentration measurement period, the second temperature-sensitive element to a third temperature range by the second heater under a condition corresponding to the disturbance information. This makes it possible to selectively detect the concentration of the gas to be detected.

In the above gas sensor, the sensitivity of the first temperature-sensitive element with respect to the gas to be detected in the first temperature range may be lower than the sensitivity of the first temperature-sensitive element with respect to the gas to be detected in the second temperature range, and the sensitivity of the second temperature-sensitive element with respect to the gas to be detected in the third temperature range may be lower than the sensitivity of the first temperature-sensitive element with respect to the gas to be detected in the second temperature range. This makes it possible to accurately measure the influence of a disturbance in measuring atmosphere irrespective of the concentration of the gas to be detected and to selectively detect the concentration of the gas to be detected.

In the above gas sensor, the sensitivity of the first temperature-sensitive element with respect to the gas to be detected in the first temperature range may be lower than the sensitivity of the second temperature-sensitive element with respect to the gas to be detected in the third temperature range, and the sensitivity of the first temperature-sensitive element with respect to the gas to be detected in the second temperature range may be lower than the sensitivity of the second temperature-sensitive element with respect to the gas to be detected in the third temperature range. This makes it possible to accurately measure the influence of a disturbance in measuring atmosphere irrespective of the concentration of the gas to be detected and to selectively detect the concentration of the gas to be detected.

In the above gas sensor, the control circuit may be configured to change power to be applied to the first heater in accordance with the disturbance information in the gas concentration measurement period. This makes it possible to heat the first temperature-sensitive element to a desired temperature even when a disturbance is present in measuring atmosphere.

In the above gas sensor, the control circuit may be configured to change the heating time of the first heater in accordance with the disturbance information in the gas concentration measurement period. This makes it possible to heat the first temperature-sensitive element to a desired temperature even when a disturbance is present in measuring atmosphere.

The above gas sensor may further include a temperature sensor that generates a temperature signal in accordance with environmental temperature, and the control circuit may be configured to change power to be applied to the first heater in accordance with the temperature signal in the gas concentration measurement period. This makes it possible to heat the first temperature-sensitive element to a desired temperature irrespective of environmental temperature.

A gas sensor according to another aspect of the present disclosure includes: a sensor part configured to generate a detection signal indicating a concentration of a gas to be detected; and a control circuit configured to calculate the concentration of the gas to be detected based on the detection signal, wherein the sensor part includes a first temperature-sensitive element, a second temperature-sensitive element, a first heater configured to heat the first temperature-sensitive element, and a second heater configured to heat the second temperature-sensitive element, and the control circuit is configured to obtain, in a disturbance information measurement period, disturbance information based on the resistance value of the first temperature-sensitive element or the resistance value of the first heater in a state where the first temperature-sensitive element is heated to a first temperature range by the first heater and obtain, in a gas concentration measurement period, the detection signal by heating the second temperature-sensitive element to a second temperature range by the second heater under a heating condition corresponding to the disturbance information. This makes it possible to accurately detect gas concentration irrespective of the influence of a disturbance in measuring atmosphere.

A gas sensor according to still another aspect of the present disclosure includes: a sensor part configured to generate a detection signal in accordance with the concentration of a gas to be detected; and a control circuit configured to calculate the concentration of the gas to be detected based on the detection signal, wherein the sensor part includes a temperature-sensitive element, a first heater, and a second heater configured to heat the temperature-sensitive element, and the control circuit is configured to obtain, in a disturbance information measurement period, disturbance information based on the resistance value of the first heater in a state where the first heater is heated to a first temperature range and obtain, in a gas concentration measurement period, the detection signal by heating the temperature-sensitive element to a second temperature range by the second heater under a heating condition corresponding to the disturbance information. This makes it possible to accurately detect gas concentration irrespective of the influence of a disturbance in measuring atmosphere while reducing a heat load on the temperature-sensitive element.

What is claimed is:

1. A gas sensor comprising:
a sensor part configured to generate a detection signal indicating a concentration of a gas to be detected; and
a control circuit configured to calculate the concentration of the gas to be detected based on the detection signal,
wherein the sensor part includes a first temperature-sensitive element and a first heater configured to heat the first temperature-sensitive element, and
wherein the control circuit is configured to:
obtain, in a disturbance information measurement period, disturbance information based on a resistance value of the first temperature-sensitive element or a resistance value of the first heater in a state where the first temperature-sensitive element is heated to a first temperature range by the first heater; and
obtain, in a gas concentration measurement period, the detection signal by heating the first temperature-sensitive element to a second temperature range by the first heater under a heating condition corresponding to the disturbance information.

2. The gas sensor as claimed in claim 1, wherein a sensitivity of the first temperature-sensitive element with respect to the gas to be detected in the first temperature range is lower than a sensitivity of the first temperature-sensitive element with respect to the gas to be detected in the second temperature range.

3. The gas sensor as claimed in claim 1,
wherein the sensor part further includes a second temperature-sensitive element and a second heater configured to heat the second temperature-sensitive element,
wherein the first and second temperature-sensitive elements are connected in series to each other,
wherein the detection signal appears at a node between the first and second temperature-sensitive elements, and
wherein the control circuit is configured to heat, in the gas concentration measurement period, the second temperature-sensitive element to a third temperature range by the second heater under a condition corresponding to the disturbance information.

4. The gas sensor as claimed in claim 3,
wherein a sensitivity of the first temperature-sensitive element with respect to the gas to be detected in the first temperature range is lower than a sensitivity of the first temperature-sensitive element with respect to the gas to be detected in the second temperature range, and
wherein a sensitivity of the second temperature-sensitive element with respect to the gas to be detected in the third temperature range is lower than a sensitivity of the first temperature-sensitive element with respect to the gas to be detected in the second temperature range.

5. The gas sensor as claimed in claim 3,
wherein a sensitivity of the first temperature-sensitive element with respect to the gas to be detected in the first temperature range is lower than a sensitivity of the second temperature-sensitive element with respect to the gas to be detected in the third temperature range, and
wherein a sensitivity of the first temperature-sensitive element with respect to the gas to be detected in the second temperature range is lower than a sensitivity of the second temperature-sensitive element with respect to the gas to be detected in the third temperature range.

6. The gas sensor as claimed in claim 1, wherein the control circuit is configured to change power to be applied to the first heater in accordance with the disturbance information in the gas concentration measurement period.

7. The gas sensor as claimed in claim 1, wherein the control circuit is configured to change a heating time of the first heater in accordance with the disturbance information in the gas concentration measurement period.

8. The gas sensor as claimed in claim 1, further comprising a temperature sensor configured to generate a temperature signal in accordance with environmental temperature,
wherein the control circuit is configured to change power to be applied to the first heater in accordance with the temperature signal in the gas concentration measurement period.

9. A gas sensor comprising:
a sensor part configured to generate a detection signal indicating a concentration of a gas to be detected; and
a control circuit configured to calculate the concentration of the gas to be detected based on the detection signal,
wherein the sensor part includes a first temperature-sensitive element, a second temperature-sensitive element, a first heater configured to heat the first temperature-sensitive element, and a second heater configured to heat the second temperature-sensitive element, and
wherein the control circuit is configured to:
obtain, in a disturbance information measurement period, disturbance information based on a resistance value of the first temperature-sensitive element or a resistance value of the first heater in a state where the first temperature-sensitive element is heated to a first temperature range by the first heater, and
obtain, in a gas concentration measurement period, the detection signal by heating the second temperature-sensitive element to a second temperature range by the second heater under a heating condition corresponding to the disturbance information.

10. The gas sensor as claimed in claim 9, wherein a sensitivity of the first temperature-sensitive element with respect to the gas to be detected in the first temperature range is lower than a sensitivity of the second temperature-sensitive element with respect to the gas to be detected in the second temperature range.

11. A gas sensor comprising:
a sensor part configured to generate a detection signal indicating a concentration of a gas to be detected; and
a control circuit configured to calculate the concentration of the gas to be detected based on the detection signal,
wherein the sensor part includes a temperature-sensitive element, a first heater, and a second heater configured to heat the temperature-sensitive element, and
wherein the control circuit is configured to:
obtain, in a disturbance information measurement period, disturbance information based on a resistance value of the first heater in a state where the first heater is heated to a first temperature range; and
obtain, in a gas concentration measurement period, the detection signal by heating the temperature-sensitive element to a second temperature range by the second heater under a heating condition corresponding to the disturbance information.

12. The gas sensor as claimed in claim 11, wherein a sensitivity of the first heater with respect to the gas to be detected in the first temperature range is lower than a sensitivity of the temperature-sensitive element with respect to the gas to be detected in the second temperature range.
